(19) United States
(12) Patent Application Publication
(10) Pub. No.: US 2026/0065372 A1
(43) Pub. Date: Mar. 5, 2026

(54) SYSTEMS AND METHODS FOR MANAGING MARKET BASED INSTRUMENTS

(71) Applicant: Honeywell International Inc., Charlotte, NC (US)

(72) Inventors: Sandhya Beejady, Bangalore (IN); Rajapriyan Thambidurai, Bangalore (IN); Sridhar Sankaranarayanan, Bangalore (IN); Dhandapani Krishnasamy, Hosur (IN)

(21) Appl. No.: 18/818,643

(22) Filed: Aug. 29, 2024

(51) Int. Cl. G06Q 40/06

(52) U.S. Cl. CPC G06Q 40/06

(57) ABSTRACT

Various embodiments described herein relate to providing and/or employing a system and a method for managing a plurality of market-based instruments in a facility. In this regard, emission factors corresponding to a plurality of assets in the facility are stored in an emission factor repository. As a result, total actual emissions corresponding to the plurality of assets is calculated based on the stored emission factors. Then the total actual emissions are compared with a carbon emission target, wherein the carbon emission target corresponds to a specific period. Furthermore, total emissions are predicted in the facility for the specific period based on the stored emission factors and a result of the comparison. Accordingly, the predicted total emissions in the facility is displayed via a user interface of a display device.

### TECHNICAL FIELD

The present disclosure is related to management of emissions in a facility. More particularly, the present disclosure relates to management of market-based instruments in the facility.

### BACKGROUND

Greenhouse gases (GHGs) such as carbon-dioxide, methane, ozone, nitrous oxide, etc. are the gases in the atmosphere that results in the greenhouse effect. GHG emissions are the primary driver of global climate change. As the GHG emissions increasing rapidly, they build up in the atmosphere and warm the climate, leading to global warming and climate change. It's widely recognized that to avoid the worst impacts of climate change, the world needs to urgently monitor and reduce these emissions. As a result, most of the facilities such as manufacturing or industrial facilities are trying to meet carbon neutral goal. In this regard, the overall emissions caused by numerous emission sources such as assets in the facility must be within the guidelines issued by the government agencies or regulatory bodies or environmental agencies. However, there are certain emissions that cannot be controlled. This leads to several challenges. For example, the facilities are becoming non-compliant to the emission guidelines. When the emissions go beyond the accepted threshold levels, then there would be financial implications corresponding to the extra tonnes of emissions that go beyond the accepted threshold levels. This may lead the facilities to pay heavy penalties for the extra tonnes of emissions. Therefore, there is a need to monitor the emissions effectively.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments, in which:

FIG. 1 is a schematic diagram illustrating a facility management system managing a plurality of facilities in accordance with one or more embodiments of the present disclosure.

FIG. 2 is a schematic diagram illustrating an exemplary facility of the plurality of facilities in accordance with one or more embodiments of the present disclosure.

FIG. 3 is a schematic diagram illustrating a framework of an Internet-of-Things (IoT) platform utilized in the facility management system in accordance with one or more embodiments of the present disclosure.

FIG. 4 is a schematic diagram illustrating an implementation of a controller of the facility management system that may execute techniques in accordance with one or more embodiments of the present disclosure.

FIG. 5A is an exemplary block diagram illustrating an implementation of a market instrument management system in the facility, in accordance with one or more embodiments of the present disclosure.

FIG. 5B is a schematic diagram illustrating the exemplary market instrument management system in accordance with one or more embodiments of the present disclosure.

FIG. 6 is an exemplary illustration of uploading a market-based instrument via a user interface, in accordance with one or more embodiments of the present disclosure.

FIG. 7 is an exemplary illustration of a plurality of market-based instruments via the user interface, in accordance with one or more embodiments of the present disclosure.

FIG. 8 is an exemplary illustration of an emission intensity prediction in the facility via the user interface, in accordance with one or more embodiments of the present disclosure.

FIG. 9 is an exemplary illustration of a financial impact prediction in the facility via the user interface, in accordance with one or more embodiments of the present disclosure.

FIG. 10 is a flowchart illustrating example operations of managing the plurality of market-based instruments in the facility, in accordance with one or more embodiments of the present disclosure.

FIG. 11 is a flowchart illustrating example operations of managing the plurality of market-based instruments in the facility, in accordance with another embodiment of the present disclosure.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for managing a plurality of market-based instruments in a facility is described. The system comprises a processor and a memory communicatively coupled to the processor. The memory comprises one or more instructions which when executed by the processor, cause the processor to store emission factors corresponding to a plurality of assets in the facility, calculate total actual emissions corresponding to the plurality of assets based on the stored emission factors, compare the total actual emissions with a carbon emission target, wherein the carbon emission target corresponds to a specific period, predict total emissions in the facility for the specific period based on the stored emission factors and a result of the comparison; and display, via a user interface of a display device, the predicted total emissions in the facility.

In accordance with an example embodiment, a method for managing a plurality of market-based instruments in a facility is described herein. The method comprises storing emission factors corresponding to a plurality of assets in the facility. Further, the method comprises calculating total actual emissions corresponding to the plurality of assets based on the stored emission factors. Also, the method further comprises comparing the total actual emissions with a carbon emission target, wherein the carbon emission target corresponds to a specific period. In this regard, the method comprises predicting total emissions in the facility for the specific period based on the stored emission factors and a result of the comparison. In addition, the method further comprises displaying, via a user interface of a display device, the predicted total emissions in the facility for the specific period.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one example embodiment of the present disclosure, and may be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some example embodiments, or it may be excluded.

One or more example embodiments of the present disclosure may provide an “Internet-of-Things” or “IoT” platform in a facility that uses real-time accurate models and visual analytics to manage a plurality of market-based instruments (also known as “carbon certificates”) in the facility. The facility may include a plurality of sites at different geographic locations. In addition, the platform provides analysis related to emission levels associated with numerous emission sources in the facility and overall emission levels of the facility as well. The IoT platform is an extensible platform that is portable for deployment in any cloud or data center environment for providing an enterprise-wide, top to bottom view, displaying status of processes, assets, people, and/or safety. Further, the IoT platform of the present disclosure supports end-to-end capability to execute digital twins against process data to provide prediction related to the emission levels and corresponding financial implications. Further, recommendations related to at least one carbon certificate that could be applied to achieve carbon offsetting across the facility is also provided.

A facility such as a manufacturing facility or an industrial facility often involves numerous assets to carry out various processes in the facility. The assets may be required to handle one or more raw materials or intermediate products. In one example, if the industrial facility corresponds to a natural gas plant, then the assets may be required to handle materials such as hydrocarbons, carbon dioxide, hydrogen sulfide, nitrogen, and/or the like. In another example, if the industrial facility corresponds to a petroleum refinery, then the assets may be required to handle materials such as crude oil. When the assets handle such materials, there may be associated emissions. The emissions may be, but not limited to carbon emissions, greenhouse gas emissions, etc.

Nowadays, most of the facilities are trying to meet carbon neutral goal. In this regard, the overall emissions caused by different assets in the facility must be within the guidelines issued by the government agencies or regulatory bodies or environmental agencies. However, there are certain emissions that cannot be controlled. For example, at a particular facility, the overall emissions caused by different assets such as boilers, chillers, turbines, etc. is 30 metric tonnes per year. However, based on the issued guidelines, overall emissions at the facility cannot exceed 25 metric tonnes per year. Therefore, there would be financial implication corresponding to the extra 5 metric tonnes of emissions since it goes beyond the accepted threshold levels i.e. 25 metric tonnes. One of the major challenges faced by the facilities today is to monitor their year-end emissions at site level to ensure that the overall emissions are under the accepted threshold levels as mandated by the government agencies or regulatory bodies. Every increase in the Tonnes of emissions yields in corresponding financial value that the facility must pay year on year. Apart from financial implications, the facilities would have to explain the cause of the breach in the threshold in the Environmental, Social and Governance (ESG) reporting to answer the concerned investors and repeated breach may make the impact more negative.

One possible solution in order to meet the carbon neutral goal is to invest in carbon offsetting program. This program helps the facilities to offset and compensate their emissions by purchasing carbon credits from market vendors, thereby achieving carbon neutrality. In this regard, carbon offset is an important market-based instrument or a tradable instrument or a financial instrument that enable the facilities to compensate their emissions by investing in projects that reduce, avoid, or remove emissions from the atmosphere. These market-based instruments are generally location or region specific because the emissions are occurring in a particular location or a region. When the facility invests in the carbon offsetting program, it receives carbon credits or tokens. These “tokens” are then used to account for net climate benefits from one facility to another. A carbon credit or carbon offset may be bought or sold after certification by a government agency, or an independent certification body based on established standards and/or protocols. One carbon offset or credit represents a reduction, avoidance or removal of one metric tonne of carbon dioxide or its carbon dioxide equivalent (CO2e). Therefore, facilities may purchase carbon credits in the form of the carbon certificates such as Renewable Energy Certificates (RECs), Power Purchase Agreement (PPAs), Certified Emission Reductions (CERs), and/or like that permit facilities to emit greenhouse gases beyond threshold levels. Main types of RECs could be General Renewable Energy Certificates (GRECs), Solar Renewable Energy Certificates (SRECs), Wind Renewable Energy Certificates (WRECs), Hydro Renewable Energy Certificates (HRECs), Biomass Renewable Energy Certificates (BRECs), Geothermal Renewable Energy Certificates (GRECs). Carbon certificates are market-based instruments or financial instruments that represent the reduction, avoidance, or removal of greenhouse gas emissions from the atmosphere. They are a key mechanism in efforts to mitigate climate change and achieve carbon neutrality. Carbon credits are generated through various activities such as, but may not be limited to, Renewable Energy Projects, Energy Efficiency Initiatives, Afforestation and Reforestation, Industrial Processes such as Carbon Capture and Storage (CCS).

However, the main challenge faced by the facilities is to manage multiple the market-based instruments or carbon certificates. Over the period, the market-based instruments may grow to a very large number. Further, international market-based instruments may add more complexity for large facilities. Assuming that the facility is having multiple sites/plants/units/production factories spread across different geographical regions, then it is exceedingly difficult to manage such large number of market-based instruments across the multiple sites of the facility. It is challenging to track details of carbon certificates such as issuance date, certificate standard, verification status, retirement or expiry date, ledger information, financial data, regional data, and/or like. Further, it is difficult to maintain and update the system of records manually. Further, it is time-consuming to check and verify that all carbon certificates meet established standards and regulatory requirements. Also, it is very difficult to determine the right carbon certificate that may be applied to offset the emissions.

Accordingly, there is a need to manage the market-based instruments effectively while ensuring that the overall carbon emissions are within the guidelines as proposed by the government agencies or the regulatory bodies. Further, there is a need to monitor lifecycle for the market-based instruments from issuance to retirement or sale. Also, there is a need to monitor carbon markets and market prices to assess the value and liquidity of the market-based instruments. There is a need to track status and performance of the market-based instruments, including emission reductions, financial implications, avoiding expiry of unused carbon credits, etc. to bring in efficiency in optimal carbon offsetting. Furthermore, determining and applying the right market-based instrument in line with the carbon emission target is vital for the sites or the facilities. Also, the present invention aims towards achieving reduction in percentage of carbon emissions with every passing year.

Thus, to address the above challenges, various examples of systems and methods described herein relate to managing emissions in the facility. In this regard, various example embodiments described herein facilitate a market instrument management system used to manage the market-based instruments or the carbon certificates in the facility. Per this aspect, the systems and methods described herein store information related to asset hierarchy in an asset database. The information may also include, but not limited to, emission levels associated with the assets, asset location data, asset identification data. Further, various example embodiments described herein store carbon certificates and associated contextual information in a market-based instrument repository. The contextual information includes, but not limited to, ledger information associated with the carbon certificates. Further, various example embodiments described herein store emission factors corresponding to various emission sources such as assets in an emission factor repository. Using all the stored information, emission calculations associated with the emission sources and various processes are provided to analyze emission levels. Further, various example embodiments described herein compare the total actual emissions with the carbon emission target to generate a result of the comparison. Further, various example embodiments described herein predict, using Artificial Intelligence/Machine Learning (AI/ML) algorithm, total emissions for all gas types, emission intensity, and financial impact associated with the predicted total emissions for the specific period. Further, various example embodiments described herein recommend, using the AI/ML algorithm, at least one carbon certificate that could be applied to achieve carbon offsetting across the facility. The AI/ML algorithm considers a plurality of data points such as, but not limited to validity of the carbon certificate, availability of the carbon certificate, applicable region, residual emission factor, financial implication, to recommend at least one right carbon certificate for applying at a particular site of the multiple sites across the facility. Further, various example embodiments described herein display the predictions and recommendations on a user interface of a display device.

Further, various example embodiments described herein translate the predicted total emissions to understandable insights. In one example, the insights may be related to carbon offsetting in the facility. In yet another example, the insights may be opportunities or corrective actions for managing emissions such as, but not limited to replacing at least one asset, servicing at least one asset in the facility, and/or the like. In yet another example, the insights may be related to recommending appropriate carbon certificates to be applied to achieve carbon offsetting. The insights may be in the form of reports, trends, charts, graphs, and/or like. The aforementioned exemplary insights facilitate the systems and methods described herein to undertake relevant actions so as to efficiently manage the emissions in the facility.

In addition, the systems and methods described herein also render the insights on a display. For example, the display may be of a mobile device associated with personnel in the facility. The systems and methods described herein translate the predicted total emissions to understandable insights so that the personnel even with minimal domain knowledge may understand and relate context of the insights. This facilitates the user to make appropriate decisions and undertake relevant actions to manage emissions in the facility. With the insights, the emission levels of each asset and associated impacts on other assets clearly fall under purview of the market instrument management system and the personnel as well. In some situations, the personnel may also apply their domain knowledge to additionally provide feedback on the insights rendered on the display so that the relevancy of insights may be improved.

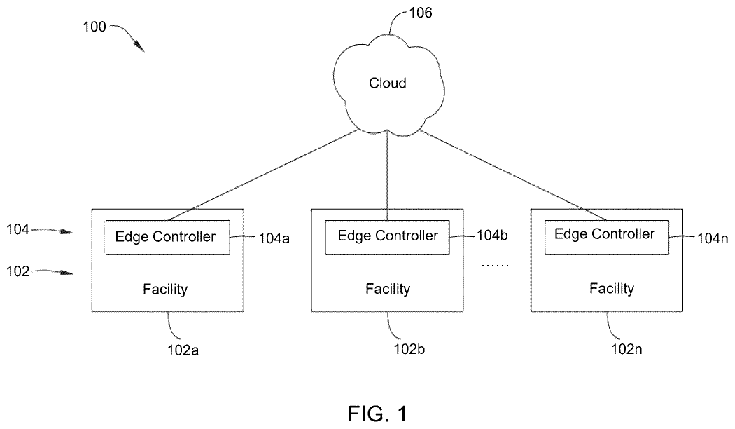

FIG. 1 illustrates a schematic diagram showing a facility management system to manage multiple facilities in accordance with one or more example embodiments described herein. According to various example embodiments described herein, the exemplary facility management system 100 comprises one or more facilities 102a, 102b, . . . 102n (collectively “facilities 102”). In this regard, a facility of the one or more facilities 102a, 102b, . . . 102n may correspond to, for example, an industrial plant, a refinery, a factory, an industry, a corporate office, a logistics environment, an airport premises, a transportation hub, a material handling environment, a warehouse, a distribution center, a sortation center, a supply chain environment, a manufacturing unit, a pharmaceutical unit, a production plant, and/or the like. In some example embodiments, the one or more facilities 102a, 102b, . . . 102n in the illustrative system 100 may be of same type. In some example embodiments, the one or more facilities 102a, 102b, . . . 102n in the illustrative system 100 may be of different type. As it may be understood, in some example embodiments described herein, each of the facilities 102 often include one or more assets such as valves, pumps, compressors, pipelines, boilers, chillers, fans, turbines, machineries, controllers, and/or the like based on a nature of the facility. But generally, the one or more assets are operated to handle one or more processes in the facility. For example, if the facility corresponds to a production plant, then the one or more assets are operated to handle an industrial process. In some instances, the industrial process may correspond to a production process to produce tangible materials. However, at times, it should be noted that the process to produce tangible materials may lead to several emissions. There may be several factors responsible for such emissions. In an example, type of materials (say, hydrocarbons, carbon dioxide, hydrogen sulfide, nitrogen, aluminum, and/or the like) handled by the one or more assets are responsible for emissions. In another example, age of an asset, leakages, loose connections, and/or the like are also responsible for emissions. Though these are few exemplary factors contributing to emissions, there may be several other factors too. As long as the emissions are detrimental and violate emission limits set by regulatory, it becomes necessary to identify factors contributing to emissions so that actions may be taken in a timely manner to manage the emissions.

Further, in one or more example embodiments described herein, each of the one or more facilities 102a, 102b, . . . 102n includes a respective edge controller 104a, 104b, . . . 104n (collectively “edge controllers 104”). Per this aspect, the edge controller of the respective facility collects data associated with the one or more assets in the facility. In accordance with some example embodiments, one or more sensors are employed in the facility to sense the data associated with the one or more assets. In this regard, the one or more sensors sense data such as emission level associated with the one or more assets, a type of material handled by the one or more assets, a process that is handled by the one or more assets, and/or the like. In accordance with some example embodiments, the one or more sensors is communicatively coupled with the edge controller of the facility. Accordingly, the edge controller of the facility receives the data associated with the one or more assets via the one or more sensors. In addition, in some example embodiments, the edge controllers 104 process the data received from the one or more sensors to derive insights associated with each of the one or more assets. In this regard, the insights may be related to emission levels, and/or the like associated with each of the one or more assets. Also, in some example embodiments, the edge controllers 104 predict trends and/or undertake one or more corrective actions to offset the emissions within the facility based on the recommended carbon certificate.

Further, in some example embodiments, the one or more facilities 102a, 102b, . . . 102n may be operably coupled with a cloud 106, meaning that communication between the cloud 106 and the one or more facilities 102a, 102b, . . . 102n is enabled. In some example embodiments, the one or more edge controllers 104a, 104b, . . . 104n may be communicatively coupled to the cloud 106. The cloud 106 may represent distributed computing resources, software, platform or infrastructure services which may enable data handling, data processing, data management, and/or analytical operations on the data exchanged & transacted amongst the facilities 102. In accordance with some example embodiments, the data collected by the edge controllers 104 is uploaded to the cloud 106 for processing. Further, in accordance with some example embodiments, the cloud 106 processes the data to determine the emission levels, and/or the like associated with each of the one or more assets. In this regard, the cloud 106 also derives the insights associated with the emission levels, and/or the like. Also, in some example embodiments, the cloud 106 may generate one or more predictions, one or more recommendations, and/or corrective actions based on the derived insights. Additionally, in some example embodiments, the cloud 106 may transmit the one or more predictions, the one or more recommendations, and/or corrective actions to a respective edge controller of the one or more edge controllers 104a, 104b, . . . 104n in the facility. Also, in some example embodiments, the cloud 106 may transmit the insights, the one or more predictions, the one or more recommendations, and/or corrective actions to a mobile device associated with the personnel in the facility.

In some example embodiments, the one or more edge controllers 104a, 104b, . . . 104n may operate as intermediary node to transact data between a respective facility and/or the cloud 106. In some example embodiments, each of the one or more edge controllers 104a, 104b, . . . 104n is capable of processing and/or filtering the collected data so as to be compatible with the cloud 106. In some example embodiments, each of the one or more facilities 102a, 102b, . . . 102n may comprise a respective gateway to transact data between a respective facility and/or the cloud 106. Accordingly, in some example embodiments, gateway may operate as intermediary node to transact data between a respective facility and/or the cloud 106. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower level computer server (or servers) processes telemetry data, for example, while a higher-level computer server oversees operation of the lower level computer server or servers.

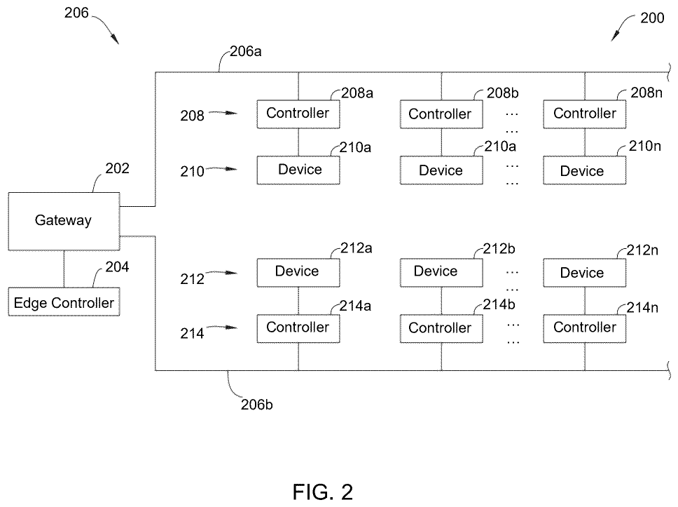

FIG. 2 illustrates a schematic diagram showing an exemplary facility in accordance with one or more example embodiments described herein. In one or more example embodiments, an example facility 200 described herein corresponds to one of the facilities 102 described in accordance with FIG. 1 of the current disclosure. In various example embodiments, the example facility 200 of FIG. 2 comprises assets communicatively coupled via multiple networks 206 (e.g., communication channels). For instance, as illustrated in FIG. 2, the facility 200 includes a first network 206a and a second network 206b. In some example embodiments, the facility 200 may include only a single network 206. In some example embodiments, the facility 200 may include multiple networks 206. Each of the networks 206 may include any available network infrastructure. In some example embodiments, each of the networks 206 may independently be, for example, a BACnet network, a NIAGARA network, a NIAGARA CLOUD network, or others. Accordingly, in some example embodiments, the facility 200 comprises a plurality of assets and/or devices in communication with a gateway 202 via corresponding communication channel (e.g., networks 206a and/or 206b). Said differently, each of the network represents a sub-network supported by an underlined network communication/IoT protocol and incorporating a cluster of endpoints (e.g. assets, controllers etc. in building facility).

In some example embodiments, one or more first assets 210a, 210b, . . . 210n (collectively “first assets 210”) are operably coupled to the first network 206a via one or more first controllers 208a, 208b, . . . 208n (collectively “first controllers 208”). In some other example embodiments, the first controllers 208 are operably coupled to one or more sensors associated with different types of the first assets 210 within the facility 200. The first assets 210 represent different types of emission sources that are present within the facility 200. The emission sources may include, but not limited to, stationary sources, mobile sources, process emissions, or indirect sources. In some example embodiments, at least some of the first assets 210 are, but not limited to actuators, valves, turbines, boilers, chillers, compressors, pumps, and/or the like. In this regard, the one or more sensors may correspond to cameras, gas detectors, flow meters, temperature sensors, pressure sensors, heat sensors, flow rate sensors, position sensors, and/or the like. Per this aspect, the one or more sensors sense telemetry data such as emission levels, a type of material handled, a process handled, and/or the like associated with the first assets 210. The emission levels may be calculated via the flow meters, or direct measurement methods such as, but not limited to, gas cloud imaging (GCI), sensors, drones, satellites, etc. In an example, the flow meters may be installed on relevant equipment or pipelines to measure the amount of fuel consumed over a specific period. In another example, the drones may collect visual or sensor data to assess the scale and intensity of activities related to the emissions sources. In yet another example, a gas cloud imaging (GCI) camera may be used to sense emission data (say, gas speciation and concentration along with geospatial co-ordinates) associated with at least some of the emission sources. In this regard, the gas cloud imaging (GCI) camera transmits the emission data to a corresponding first controller of the first controllers 208. In some example embodiments, the overall emissions at the specific site or the facility may be calculated using emission factors that quantify an amount of CO2-equivalent emissions produced per unit of activity or energy consumed. Further, in some example embodiments, the one or more sensors transmit the telemetry data to the first controllers 208.

In some example embodiments, the first controllers 208 control operation of at least one of the first assets 210. In this regard, the first controllers 208 process and/or analyze the telemetry data to derive one or more insights for at least some of the first assets 210 in the facility 200. In this regard, the insights may be related to the emission levels, and/or the like associated with at least some of the first assets 210. Also, in some example embodiments, the first controllers 208 predict trends and/or undertake one or more corrective actions based at least on the derived insights to control at least some of the first assets 210 and manage emissions of the facility 200. For example, a trend may correspond to a predicted emission trend of a particular gas type in the facility 200. Based on the predicted emission trend, the first controllers 208 may recommend an appropriate carbon certificate to offset the emissions in the facility 200. Further, the first controllers 208 may determine the financial implication corresponding to the predicted emission trend. In accordance with some example embodiments, the first controllers 208 may be built into one or more of the corresponding first assets 210 and need not be a separate component. Whereas, in accordance with some other example embodiments, the first controllers 208 may be virtual controllers that may be implemented within a virtual environment hosted by one or more computing devices (not illustrated). In another example embodiment, at least some of the first assets 210 may be controllers. In such case, the first assets 210 need not have a separate corresponding controller of the first controllers 208.

In some example embodiments, one or more second assets 212a, 212b, . . . 212n (collectively “second assets 212”), are operably coupled to the second network 206b via one or more second controllers 214a, 214b, . . . 214n (collectively “second controllers 214”). In some other example embodiments, the second controllers 214 are operably coupled to one or more sensors associated with different types of the second assets 212 within the facility 200. The second assets 212 represent different types of emission sources that are present within the facility 200. The emission sources may include, but not limited to, stationary sources, mobile sources, process emissions, or indirect sources. In some example embodiments, at least some of the second assets 212 are, but not limited to actuators, valves, turbines, boilers, chillers, compressors, pumps, and/or the like. In this regard, the one or more sensors may correspond to cameras, gas detectors, flow meters, temperature sensors, pressure sensors, heat sensors, flow rate sensors, position sensors, and/or the like. Per this aspect, the one or more sensors sense telemetry data such as emission levels, a type of material handled, a process handled, and/or the like associated with the second assets 212. The emission levels may be calculated via the flow meters, or direct measurement methods such as, but not limited to, gas cloud imaging (GCI), sensors, drones, satellites, etc. In an example, the flow meters may be installed on relevant equipment or pipelines to measure the amount of fuel consumed over a specific period. In another example, the drones may collect visual or sensor data to assess the scale and intensity of activities related to the emissions sources. In yet another example, a gas cloud imaging (GCI) camera may be used to sense emission data (say, gas speciation and concentration along with geospatial co-ordinates) associated with at least some of the emission sources. In this regard, the gas cloud imaging (GCI) camera transmits the emission data to a corresponding second controller of the second controllers 214. In some example embodiments, the overall emissions at the specific site or the facility may be calculated using emission factors that quantify an amount of CO2-equivalent emissions produced per unit of activity or energy consumed. Further, in some example embodiments, the one or more sensors transmit the telemetry data to the second controllers 214.

In some example embodiments, the second controllers 214 control operation of at least one of the second assets 212. In this regard, the second controllers 214 process and/or analyze the telemetry data to derive one or more insights for at least some of the second assets 212 in the facility 200. In this regard, the insights may be related to the emission levels, and/or the like associated with at least some of the first assets 210. Also, in some example embodiments, the second controllers 214 predict trends and/or undertake one or more corrective actions based at least on the derived insights to control at least some of the second assets 212 and manage emissions of the facility 200. For example, a trend may correspond to a predicted emission trend of a particular gas type in the facility 200. Based on the predicted emission trend, the second controllers 214 may recommend an appropriate carbon certificate to offset the emissions in the facility 200. Further, the second controllers 214 may determine the financial implication corresponding to the predicted emission trend. In accordance with some example embodiments, the second controllers 214 may be built into one or more of the corresponding second assets 212 and need not be a separate component. Whereas, in accordance with some other example embodiments, the second controllers 214 may be virtual controllers that may be implemented within a virtual environment hosted by one or more computing devices (not illustrated). In another example embodiment, at least some of the second assets 212 may be controllers. In such case, the second assets 212 need not have a separate corresponding controller of the second controllers 214.

Further, in some example embodiments, the facility 200 includes a gateway 202 that is operably coupled with the first network 206a and the second network 206b. In one example embodiment, the gateway 202 may be operably coupled with the first network 206a but not with the second network 206b. In another example embodiment, the gateway 202 may be operably coupled with the second network 206b but not with the first network 206a. Accordingly, in some example embodiments, the gateway 202 is a legacy controller. In some example embodiments, the gateway 202 may be absent. In accordance with some example embodiments, an edge controller 204 is installed within the facility 200. In some example embodiments, the edge controller 204 may be operably coupled with the gateway 202. In this regard, the edge controller 204 serves as an intermediary node between the first controllers 208, the second controllers 214, and the cloud 106 (as described in accordance with FIG. 1 of the current disclosure). For instance, in an example, the edge controller 204 may pull data from the first controllers 208 and the second controllers 214 and provide the data to the cloud 106. In an example embodiment, the edge controller 204 is configured to discover the first assets 210, the second assets 212, the first controllers 208, and/or the second controllers 214 that are connected along a local network such as the network 206. In an example embodiment, the network protocol of the network 206 includes discovery commands that, for example, are used to request that all assets connected to the network 206 identify themselves. Whereas, in another example, the edge controller 204 is configured to discover the first assets 210 and the second assets 212 regardless of an underlaying protocol supported by the first assets 210 and the second assets 212. In other words, the edge controller 204 may discover the first assets 210 and the second assets 212 supported by different protocols (e.g., BACnet, Modbus, LonWorks, SNMP, MQTT, Foxs, OPC UA etc.).

Further, in some example embodiments, the edge controller 204 interrogates any assets it finds operably coupled to the network 206 to obtain additional information from those assets that further helps the edge controller 204 and/or the cloud 106 identify the connected assets (such as, but not limited to actuators, valves, compressors, pumps), functionality of the assets, connectivity of the local controllers and/or the assets, types of operational data that is available from the local controllers and/or the assets, types of alarms that are available from the local controllers and/or the assets, and/or any other suitable information. For purpose of brevity, the additional information requested from the assets is referred interchangeably as, ‘metadata’, ‘semantic data’, or ‘the model data’, hereinafter throughout the description.

More generally, and in some example embodiments, the edge controller 204 is communicatively coupled to one or more assets, via one or more networks. For purpose of brevity, the term ‘assets’ is also referred interchangeably to as ‘data points’, ‘end points’, ‘devices’, ‘sensors’, or ‘electronic devices’ throughout the description. According to various example embodiments described herein, the assets may be, for example, but not limited to, sensors, electronic components, pressure valves, HVACs, alarm units, building management systems, building controllers, industrial subsystems, industrial controllers, lightning systems, air detective systems, air quality sensors, etc. These may correspond to, for example, one or more of the first assets 210 and the second assets 212.

According to an example embodiment, the edge controller 204 is configured to receive at least one of, the telemetry data and model data from the one or more assets corresponding to various independent and diverse sub-systems in the facility 200 (e.g., but not limited to, a building, an industrial plant, a warehouse, a factory, etc.). The one or more assets correspond to various independent and diverse sub-systems in the facility 200. In some examples, the telemetry data may represent time-series data and may include a plurality of data values associated with the assets which may be collected over a period of time. For instance, in an example, the telemetry data may represent a plurality of sensor readings collected by a sensor over a period of time. Further, the model data may represent meta-data associated with the assets. The model data may be indicative of ancillary or contextual information associated with the asset. For instance, in an example, the model data may be representative of geographical information associated with the asset (e.g., location of the asset) within the facility 200. In another example, the model data may represent a sensor setting based on which a sensor is commissioned within a facility 200. In yet another example, the model data may be representative of a data type or a data format associated with the data transacted through the asset. In yet another example, the model data may be indicative of any information which may define a relationship of the asset with one or more other assets in the facility 200. In accordance with various example embodiments described herein, the term ‘model data’ may be referred interchangeably as ‘semantic model’ or ‘metadata’ for purpose of brevity.

In accordance with an example embodiment, the edge controller 204 is configured to discover and identify the one or more assets which are communicatively coupled to the edge controller 204. Further, upon identification of the assets, the example edge controller 204 is configured to pull the telemetry data and/or the model data from the various identified assets. In an example, these assets may correspond to one or more electronic devices that may be located on-premises in the facility 200. The edge controller 204 is configured to pull the data by sending one or more data interrogation requests to the one or more assets. These data interrogation requests may be based on a protocol supported by an underlying one or more assets.

In accordance with an example embodiment, the edge controller 204 is configured to receive the telemetry data and/or the model data in various data formats or different data structures. In an example, a format of the telemetry data and/or the model data, received at the edge controller 204 may be in accordance with a communication protocol of the network supporting transaction of data amongst two or more network nodes (i.e., the edge controller 204 and the asset). As may be appreciated, in some example embodiments, the various assets in the facility 200 may be supported by one or more of various network protocols (e.g., IOT protocols like BACnet, Modbus, LonWorks, SNMP, MQTT, Foxs, OPC UA etc.). Accordingly, and in some cases, the edge controller 204 is configured to pull the telemetry data and/or the model data, in accordance with communication protocol supported by the one or more asset.

In some example embodiments, the edge controller 204 is configured to process the received data and transform the data into a unified data format. The unified data format is referred hereinafter as a common object model. In an example, the common object model is in accordance with an object model that may be required by one or more data analytics applications or services, supported at the cloud 106. In some example embodiments, the edge controller 204 may perform data normalization to normalize the received data into a pre-defined data format. In an example, the pre-defined format may represent a common object model in which the edge controller 204 may further push the telemetry data and/or the model data to the cloud 106. In some example embodiments, the edge controller 204 is configured to establish a secure communication channel with the cloud 106. In this regard, the data may be transacted between the edge controller 204 and the cloud 106, via the secure communication channel. In some example embodiments, the edge controller 204 may send the data to the cloud 106 automatically at pre-defined time intervals. In some example embodiments, at least a part of the data may correspond to historic data. In some example embodiments, the edge controller 204 and/or the cloud 106 may derive the one or more insights associated in the facility 200 based on the common object model as well.

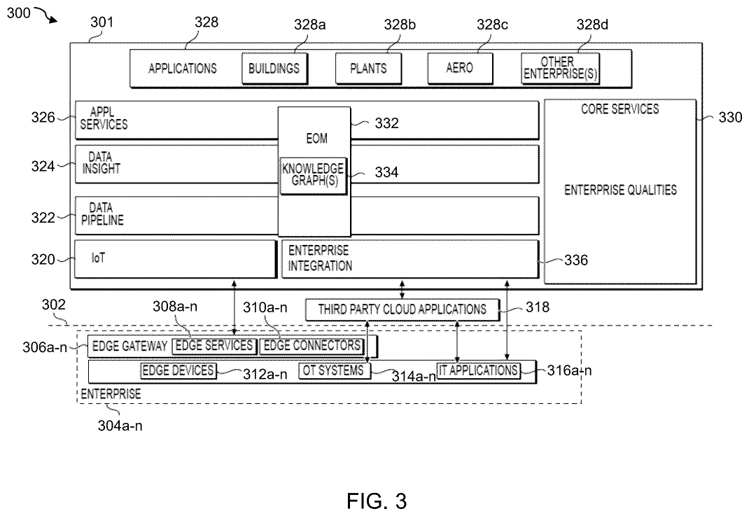

FIG. 3 illustrates a schematic diagram showing a framework of an Internet-of-Things (IoT) platform utilized in a facility management system in accordance with one or more example embodiments described herein. The IoT platform 301 of the present disclosure is a platform used by the market instrument management system that uses real-time accurate models and/or visual analytics to manage multiple market-based instruments or carbon certificates to offset the emissions in a facility. This is done to ensure sustained peak performance of the facility or enterprise 304a-304n. The IoT platform 301 is an extensible platform that is portable for deployment in any cloud or data center environment for providing an enterprise-wide, top to bottom view, displaying the status of processes, assets, people, and safety. Further, the IoT platform 301 supports end-to-end capability to execute digital twins against process data and to manage the multiple carbon certificates of the enterprise, using the framework 300, detailed further below.

As shown in FIG. 3, the framework 300 of the IoT platform 301 comprises a number of layers including, for example, an IoT layer 320, an enterprise integration layer 336, a data pipeline layer 322, a data insight layer 324, an application services layer 326, and an applications layer 328. The IoT platform 301 also includes a core services layer 330 and an extensible object model (EOM) 332 comprising one or more knowledge graphs 334. The layers 320-330 further include various software components that together form each layer 320-330. For example, in one or more embodiments, each layer 320-330 includes one or more of the modules, models, engines, databases, services, applications, or combinations thereof. In some embodiments, the layers 320-330 are combined to form fewer layers. In some embodiments, some of the layers 320-330 are separated into separate, more numerous layers. In some embodiments, some of the layers 320-330 are removed while others may be added.

The IoT platform 301 is a model-driven architecture. Also, in some example embodiments, the IoT platform 301 receives telemetry data from one or more assets (e.g., edge devices 312a-312n). In accordance with certain embodiments, the extensible object model (EOM) 332 communicates with each layer 320-330 to contextualize site data of the enterprise 304a-304n using an extensible object model (or “asset model”) and knowledge graphs 334 where the one or more assets (e.g., edge devices 312a-312n) and processes of the facility or the enterprise 304a-304n are modeled. In an example embodiment, the edge devices 312a-312n may be one of the one or more assets as illustrated in FIGS. 1 and 2 of the current disclosure. The knowledge graphs 334 of EOM 332 are configured to store the models in a central location. The knowledge graphs 334 define a collection of nodes and links that describe real-world connections that enable smart systems. As used herein, a knowledge graph 334: (i) describes real-world entities (e.g., edge devices 312a-312n) and their interrelations organized in a graphical interface; (ii) defines possible classes and relations of entities in a schema; (iii) enables interrelating arbitrary entities with each other; and (iv) covers various topical domains. In other words, the knowledge graphs 334 define large networks of entities (e.g., edge devices 312a-312n), semantic types of the entities, properties of the entities, and relationships between the entities. Thus, the knowledge graphs 334 describe a network of “things” that are relevant to a specific domain, an enterprise, or a facility. Knowledge graphs 334 are not limited to abstract concepts and relations, but may also contain instances of objects, such as, for example, documents and datasets. In some example embodiments, the knowledge graphs 334 include resource description framework (RDF) graphs. As used herein, a “RDF graph” is a graph data model that formally describes the semantics, or meaning, of information. The RDF graph also represents metadata (e.g., data that describes data). In some example embodiments, the knowledge graphs 334 comprises data related to operating boundary and/or safety limits associated with each of the one or more assets. Whereas in some example embodiments, the knowledge graphs 334 comprises data related to emissions associated with each of the one or more assets in the facility and/or one or more emission calculations. Also, in some example embodiments, the knowledge graphs 334 comprises data related to standard emissions set by regulatory. In accordance with some example embodiments, the knowledge graphs 334 comprises one or more insights related to emission levels, and/or the like associated with each of the one or more assets. In this regard, the one or more insights of the knowledge graphs 334 may be reasons, opportunities, corrective actions, predictions, and/or recommendations associated with the carbon certificates so as to effectively manage emissions in the facility. Further, the knowledge graphs 334 may be used to create one or more service cases based at least on the one or more insights. According to various example embodiments, the knowledge graphs 334 may also include a semantic object model. The semantic object model is a subset of a knowledge graph 334 that defines semantics for the knowledge graph 334. For example, the semantic object model defines the schema for the knowledge graph 334.

As used herein, EOM 332 is a collection of application programming interfaces (APIs) that enables seeded semantic object models to be extended. For example, the EOM 332 of the present disclosure enables a customer's knowledge graph 334 to be built subject to constraints expressed in the customer's semantic object model. Thus, the knowledge graphs 334 are generated by customers (e.g., enterprises or organizations) to create models of the edge devices 312a-312n using their corresponding data in the enterprise 304a-304n, and the knowledge graphs 334 are input into the EOM 332 for visualizing the models (e.g., the nodes and links). In some example embodiments, knowledge graphs 334 are input into the EOM 332 for visualizing overall emissions of the facility, emissions associated with each of the one or more assets in the facility, impact of emissions associated with an asset on the overall emissions of the facility, and/or the one or more insights.

The models describe the one or more assets (e.g., the nodes) of the enterprise (e.g., the edge devices 312a-312n) and describe the relationship between the one or more assets (e.g., the links). The models also describe the schema (e.g., describe what the data is), and therefore the models are self-validating. For example, in one or more embodiments, the model describes the type of sensors mounted on any given asset (e.g., edge device 312a-312n) and the type of data that is being sensed by each sensor. Accordingly, the IoT platform 301 is an extensible, model-driven end-to-end stack including: two-way model sync and secure data exchange between the edge and the cloud, metadata driven data processing (e.g., rules, calculations, and aggregations), and model driven visualizations and applications. As used herein, “extensible” refers to the ability to extend a data model to include new emission data, new standard emission regulations, new rules, new properties, new columns, new fields, new classes, new tables, new operating levels of the one or more assets, new insights, and/or new relations. Thus, the IoT platform 301 is extensible with regards to edge devices 312a-312n and the applications that handle those devices 312a-312n. For example, when new edge devices are added to an enterprise 304a-304n system, the new devices will automatically appear in the IoT platform 301. In addition, the IoT platform 301 receives telemetry data from the new devices along with the existing edge devices 312a-312n. Accordingly, the IoT platform 301 has the capability to generate models associated operations and/or emissions for the new devices in near-real time based at least on the telemetry data. With this, the corresponding applications 328 may understand and use the data from the new devices to manage the new devices and/or processes in the facility or the enterprise 304a-304n to ensure effective management of emissions thereby increasing overall throughput of the facility.

In some cases, asset templates are used to facilitate configuration of instances of edge devices 312a-312n in the model using common structures. An asset template defines the typical properties or parameters for the edge devices 312a-312n of a given facility or enterprise 304a-304n for a certain type of device or asset. In this regard, some of the typical properties are static in nature. For example, an asset template of a pump includes modeling the pump having inlet and outlet pressures, speed, flow, etc. In other words, these properties such as pressure, speed, flow etc., for which the pump is configured to measure or sense is static. However, values or measurements sensed by the pump in real-time for the corresponding properties and/or emissions associated with the pump are dynamic in nature. Said alternatively, based on a process handled, a throughput of the enterprise 304a-304n, and/or a type of material handled by the pump, the measurements and/or the emissions vary dynamically. In this regard, the asset template of the pump may be dynamically updated in a timely manner. Also, it is to be noted that the templates may also include hierarchical or derived types of edge devices 312a-312n to accommodate variations of a base type of device 312a-312n. For example, a reciprocating pump is a specialization of a base pump type and would include additional properties in the template. Instances of the edge device 312a-312n in the model are configured to match the actual, physical devices of the enterprise 304a-304n using the templates to define expected attributes of the device 312a-312n. Each attribute is configured either as a static value (e.g., capacity is 1000 BPH) or with a reference to a time series tag that provides the value. The knowledge graph 334 may automatically map the tag to the attribute based on naming conventions, parsing, and matching the tag and attribute descriptions and/or by comparing the behavior of the time series data with expected behavior.

In certain example embodiments, the modeling phase includes an onboarding process for syncing the models between the edge and the cloud. In some example embodiments, the modeling phase may also include construction of the knowledge graph 334 using the telemetry data received from the one or more assets in the enterprise 304a-304n. For example, in one or more example embodiments, the onboarding process includes a simple onboarding process, a complex onboarding process, and/or a standardized rollout process. The simple onboarding process includes the knowledge graph 334 receiving raw model data from the edge and running context discovery algorithms to generate the model. The context discovery algorithms read the context of the edge naming conventions of the edge devices 312a-312n and determine what the naming conventions refer to. For example, in one or more example embodiments, the knowledge graph 334 receives “TMP” during the modeling phase and determines that “TMP” relates to “temperature”. The generated models are then published. In certain example embodiments, the complex onboarding process includes the knowledge graph 334 receiving the raw model data, receiving point history data, and receiving site survey data. According to various example embodiments, the knowledge graph 334 then uses these inputs to run the context discovery algorithms. According to various example embodiments, the generated models are edited and then the models are published. The standardized rollout process includes manually defining standard models in the cloud and pushing the models to the edge.

The IoT layer 320 includes one or more components for device management, data ingest, and/or command/control of the edge devices 312a-312n. The components of the IoT layer 320 enable data to be ingested into, or otherwise received at, the IoT platform 301 from a variety of sources. For example, in one or more example embodiments, data is ingested from the edge devices 312a-312n through process historians or laboratory information management systems. The IoT layer 320 is in communication with the edge connectors 310a-310n installed on the edge gateways 306a-306n through network 302, and the edge connectors 310a-310n send the data securely to the IoT platform 301. In some example embodiments, the edge connectors 310a-310n may correspond to edge controller 204 described in accordance with FIG. 2 of the current disclosure. In some example embodiments, only authorized data is sent to the IoT platform 301, and the IoT platform 301 only accepts data from authorized edge gateways 306a-306n and/or edge devices 312a-312n. According to various example embodiments, data is sent from the edge gateways 306a-306n to the IoT platform 301 via direct streaming and/or via batch delivery. In some example embodiments, the edge gateways 306a-306n may correspond to gateway 202 described in accordance with FIG. 2 of the current disclosure. Further, after any network or system outage, data transfer will resume once communication is re-established and any data missed during the outage will be backfilled from the source system or from a cache of the IoT platform 301. According to various example embodiments, the IoT layer 320 also includes components for accessing time series, alarms and events, and transactional data via a variety of protocols.

The enterprise integration layer 336 includes one or more components for events/messaging, file upload, and/or REST/OData. The components of the enterprise integration layer 336 enable the IoT platform 301 to communicate with third party cloud applications 318, such as any application(s) operated by an enterprise in relation to its edge devices. For example, the enterprise integration layer 336 connects with enterprise databases, such as guest databases, customer databases, financial databases, patient databases, etc. The enterprise integration layer 336 provides a standard application programming interface (API) to third parties for accessing the IoT platform 301. The enterprise integration layer 336 also enables the IoT platform 301 to communicate with the OT systems 314a-314n and IT applications 316a-316n of the enterprise 304a-304n. Thus, the enterprise integration layer 336 enables the IoT platform 301 to receive data from the third-party applications 318 rather than, or in combination with, receiving the data from the edge devices 312a-312n directly. In accordance with some example embodiments, the enterprise integration layer 336 also enables the IoT platform 301 to receive feedback from the personnel in the enterprise 304a-304n related to operations and/or emissions associated with the one or more assets.

The data pipeline layer 322 includes one or more components for data cleansing/enriching, data transformation, data calculations/aggregations, and/or API for data streams. Accordingly, in one or more example embodiments, the data pipeline layer 322 pre-processes and/or performs initial analytics on the received data. The data pipeline layer 322 executes advanced data cleansing routines including, for example, data correction, mass balance reconciliation, data conditioning, component balancing and simulation to ensure the desired information is used as a basis for further processing. In some example embodiments, the data pipeline layer 322 may process the feedback from personnel to identify new insights, new service cases, new tags, new properties, new columns, new fields, new classes, new tables, and new relations, etc., associated with operations and/or emissions of the one or more assets. The data pipeline layer 322 also provides advanced and fast computation capabilities. For example, in one or more example embodiments, cleansed data is run through enterprise-specific digital twins. According to various example embodiments, the enterprise-specific digital twins include a reliability advisor containing process models to determine the current operation and the fault models to trigger any early detection of faults and/or emissions in order to determine an appropriate resolution. According to various example embodiments, the digital twins also include an optimization advisor that integrates real-time economic data with real-time process and emission data, selects the right feed for a process, and determines optimal process conditions and product yields to effectively manage emissions in the enterprise 304a-304n.

According to various example embodiments, the data pipeline layer 322 employs models and templates to define calculations and analytics. In accordance with example embodiments, the data pipeline layer 322 employs models and templates to define how the calculations and analytics relate to the one or more assets (e.g., the edge devices 312a-312n). In one aspect, the calculations and analytics relate to operations associated with the one or more assets. For example, a calculation may relate to determination of a particular type of emission associated with an asset. In another example, a calculation may relate to correlation of emission level associated with each of the one or more assets in the enterprise 304a-304n. Further, in another example, a calculation may relate to determination of emission levels that would be associated with each of the one or more assets for a given throughput of the enterprise 304a-304n. In some example embodiments, the data pipeline layer 322 also employs the calculations and analytics to predict trends associated with the operations and/or emissions associated with the one or more assets. For example, a fan template defines fan efficiency calculations such that every time a fan is configured, the standard efficiency calculation is automatically executed for the fan. In another example, a pump template outputs emission calculations such that every time a pump is configured to handle a particular process, the emission calculations is automatically outputted for the pump. The calculation model defines the various types of calculations, the type of engine that should run the calculations, the input and output parameters, the preprocessing requirement and prerequisites, the schedule, expected throughput, etc. According to various example embodiments, the actual calculation or analytic logic is defined in the template or it may be referenced. Thus, according to various example embodiments, the calculation model is employed to describe and control the execution of a variety of different process models and thereby operation of the one or more assets. According to various example embodiments, calculation templates are linked with the asset templates such that when an asset (e.g., edge device 312a-312n) instance is created, any associated calculation instances are also created with their input and output parameters, operating limits, admissible emission limits, and/or the like linked to the appropriate attributes of the asset (e.g., edge device 312a-312n). According to various example embodiments, the data pipeline layer 322 may identify one or more insights based on the calculations and analytics as well.

According to various example embodiments, the IoT platform 301 supports a variety of different analytics models including, for example, curve fitting models, regression analysis models, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 304a-304n performance to identify issues or opportunities, and the potential causes or drivers of the issues or opportunities. The IoT platform 301 includes rich hierarchical symptom-fault models to identify abnormal conditions and their potential consequences. For example, the IoT platform 301 may identify fugitive emissions associated with an asset in the enterprise 304a-304n as an abnormal condition. Further, in another example, the IoT platform 301 may determine and/or predict a potential consequence based on the fugitive emissions. In this regard, in one or more embodiments, the IoT platform 301 drill downs from a high-level condition to understand the contributing factors, as well as determining the potential impact a lower level condition may have. There may be multiple fault models for a given enterprise 304a-304n looking at different aspects such as process, equipment, control, and/or operations. According to various example embodiments, each fault model identifies issues and opportunities in their domain, and may also look at the same core problem from a different perspective. According to various example embodiments, an overall fault model is layered on top to synthesize the different perspectives from each fault model into an overall assessment of the situation and point to the true root cause.

According to various example embodiments, when a fault or opportunity is identified, the IoT platform 301 provides one or more corrective actions, predictions, and/or recommendations to be taken in the facility. Initially, the corrective actions, predictions, and/or recommendations are based on expert knowledge that has been pre-programmed into the system by process and equipment experts. The recommendation services module presents this information in a consistent way regardless of source, and supports workflows to track, close out, and document the recommendation follow-up. According to various example embodiments, the recommendation follow-up is employed to improve the overall knowledge of the system over time as existing recommendations are validated (or not) or new cause and effect relationships are learned by users (for example, personnel in the facility) and/or analytics.

According to various example embodiments, the models are used to accurately predict what will occur before it occurs and interpret the status of the installed base. Thus, the IoT platform 301 enables personnel to quickly initiate maintenance measures when irregularities (such as fugitive emissions, asset fault, and/or the like) occur. In some example embodiments, the one or more recommendations may be created to address the irregularities in the enterprise 304a-304n. According to various example embodiments, the digital twin architecture of the IoT platform 301 employs a variety of modeling techniques. According to various example embodiments, the modeling techniques include, for example, rigorous models, fault detection and diagnostics (FDD), descriptive models, predictive maintenance, prescriptive maintenance, process optimization, and/or any other modeling technique.

According to various example embodiments, the rigorous models are converted from process design simulation. In this manner, in certain example embodiments, process design is integrated with feed conditions. Process changes and technology improvement provide business opportunities that enable more effective maintenance schedule and deployment of resources in the context of production needs with minimal emissions. The fault detection and diagnostics include generalized rule sets that are specified based on industry experience and domain knowledge and may be easily incorporated and used working together with equipment models. According to various example embodiments, the descriptive models identify a problem, and the predictive models determines possible damage levels and maintenance options (say, to mitigate emissions). According to various example embodiments, the descriptive models include models for defining the operating windows and associated operating set points for the edge devices 312a-312n.

Predictive maintenance includes predictive analytics models developed based on rigorous models and statistic models, such as, for example, principal component analysis (PCA) and partial least square (PLS). According to various example embodiments, machine learning methods are applied to train models for fault prediction. According to various example embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions such as current operating points, current emission levels, etc., rather than time-based maintenance schedule. According to various example embodiments, prescriptive analysis selects the right solution based on the company's capital, operational, and/or other requirements to ensure minimal emissions. Process optimization is determining optimal conditions via adjusting set points and schedules. The optimized set points and schedules may be communicated directly to the underlying controllers, which enables automated closing of the loop from analytics to control.

The data insight layer 324 includes one or more components for time series databases (TDSB), relational/document databases, data lakes, blob, files, images, and videos, and/or an API for data query. According to various example embodiments, when raw data is received at the IoT platform 301, the raw data is stored as time series tags or events in warm storage (e.g., in a TSDB) to support interactive queries and to cold storage for archive purposes. According to various example embodiments, data is sent to the data lakes for offline analytics development. According to various example embodiments, the data pipeline layer 322 accesses the data stored in the databases of the data insight layer 324 to perform analytics, as detailed above.

The application services layer 326 includes one or more components for rules engines, workflow/notifications, KPI framework, insights (e.g., actionable insights), decisions, recommendations, machine learning, and/or an API for application services. The application services layer 326 enables building of applications 328a-d. The applications layer 328 includes one or more applications 328a-d of the IoT platform 301. For example, according to various example embodiments, the applications 328a-d includes a buildings application 328a, a plants application 328b, an aero application 328c, and other enterprise applications 328d. According to various example embodiments, the applications 328 includes general applications for portfolio management, asset management, autonomous control, and/or any other custom applications. According to various example embodiments, portfolio management includes the KPI framework and a flexible user interface (UI) builder. According to various example embodiments, asset management includes asset performance, asset health, and/or asset predictive maintenance. According to various example embodiments, autonomous control includes energy optimization and/or predictive maintenance. As detailed above, according to various example embodiments, the general applications 328a-d is extensible such that each application 328a-d is configurable for the different types of enterprises 304a-304n (e.g., buildings application 328a, plants application 328b, aero application 328c, and other enterprise applications 328d).

The applications layer 328 also enables visualization of performance of the enterprise 304a-304n. For example, dashboards provide a high-level overview with drill downs to support deeper investigations. In some example embodiments, the dashboards provide one or more insights related to predicted emission levels, predicted emission intensity, predicted financial impact, and/or the like associated with each of a plurality of gas types. In this regard, the dashboards provide one or more reasons or issues, opportunities, corrective actions, recommendations, and/or the like as the one or more insights. Also, the dashboards provide one or more service cases based at least on the one or more insights. The one or more insights give users prioritized actions to address current or potential issues and opportunities. For example, a prioritized action may be recommendation of one or more appropriate carbon certificates from the stored carbon certificates to offset the emissions within the facility. In another example, a prioritized action may be recommendation of purchase of new carbon certificate to offset the emission within the facility.

The core services layer 330 includes one or more services of the IoT platform 301. According to various example embodiments, the core services 330 include data visualization, data analytics tools, security, scaling, and monitoring. According to various example embodiments, the core services 330 also include services for tenant provisioning, single login/common portal, self-service admin, UI library/UI tiles, identity/access/entitlements, logging/monitoring, usage metering, API gateway/dev portal, and the IoT platform 301 streams.

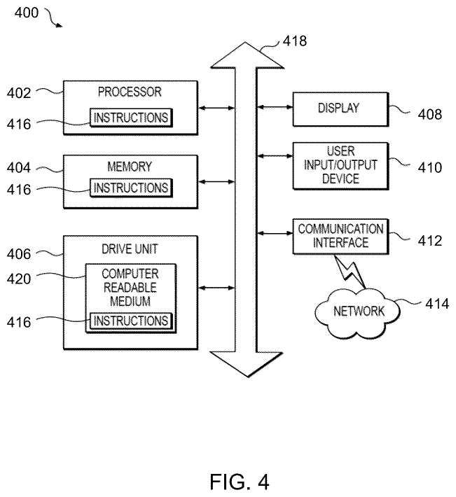

FIG. 4 illustrates a schematic diagram showing an implementation of a controller that may execute techniques in accordance with one or more example embodiments described herein. The controller 400 may include a set of instructions that may be executed to cause the controller 400 to perform any one or more of the methods or computer-based functions disclosed herein. The controller 400 may operate as a standalone device or may be connected, e.g., using a network, to other computer systems or peripheral devices.

In a networked deployment, the controller 400 may operate in the capacity of a server or as a client in a server-client user network environment, or as a peer computer system in a peer-to-peer (or distributed) network environment. The controller 400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 400 may be implemented using electronic devices that provide voice, video, or data communication. Further, while the controller 400 is illustrated as a single system, the term “system” shall also be taken to include any collection of systems or sub-systems that individually or jointly execute a set, or multiple sets, of instructions to perform one or more computer functions.

As illustrated in FIG. 4, the controller 400 may include a processor 402, e.g., a central processing unit (CPU), a graphics processing unit (GPU), or both. The processor 402 may be a component in a variety of systems. For example, the processor 402 may be part of a standard computer. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The controller 400 may include a memory 404 that may communicate via a bus 418. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 400 may further include a display 408, such as a liquid crystal display (LCD), an organic light emitting diode (OLED), a flat panel display, a solid-state display, a cathode ray tube (CRT), a projector, a printer or other now known or later developed display device for outputting determined information. The display 408 may act as an interface for the user to see the functioning of the processor 402, or specifically as an interface with the software stored in the memory 404 or in the drive unit 406.

Additionally or alternatively, the controller 400 may include an input/output device 410 configured to allow a user to interact with any of the components of controller 400. The input/output device 410 may be a number pad, a keyboard, or a cursor control device, such as a mouse, or a joystick, touch screen display, remote control, or any other device operative to interact with the controller 400.

The controller 400 may also or alternatively include drive unit 406 implemented as a disk or optical drive. The drive unit 406 may include a computer-readable medium 420 in which one or more sets of instructions 416, e.g. software, may be embedded. Further, the instructions 416 may embody one or more of the methods or logic as described herein. The instructions 416 may reside completely or partially within the memory 404 and/or within the processor 402 during execution by the controller 400. The memory 404 and the processor 402 also may include computer-readable media as discussed above.

In some systems, a computer-readable medium 420 includes instructions 416 or receives and executes instructions 416 responsive to a propagated signal so that a device connected to a network 414 may communicate voice, video, audio, images, or any other data over the network 414. Further, the instructions 416 may be transmitted or received over the network 414 via a communication port or interface 412, and/or using a bus 418. The communication port or interface 412 may be a part of the processor 402 or may be a separate component. The communication port or interface 412 may be created in software or may be a physical connection in hardware. The communication port or interface 412 may be configured to connect with a network 414, external media, the display 408, or any other components in controller 400, or combinations thereof. The connection with the network 414 may be a physical connection, such as a wired Ethernet connection or may be established wirelessly as discussed below. Likewise, the additional connections with other components of the controller 400 may be physical connections or may be established wirelessly. The network 414 may alternatively be directly connected to a bus 418.

While the computer-readable medium 420 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 420 may be non-transitory, and may be tangible.

The computer-readable medium 420 may include a solid-state memory such as a memory card or other package that houses one or more non-volatile read-only memories. The computer-readable medium 420 may be a random-access memory or other volatile re-writable memory. Additionally or alternatively, the computer-readable medium 420 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

The controller 400 may be connected to a network 414. The network 414 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 414 may include wide area networks (WAN), such as the Internet, local area networks (LAN), campus area networks, metropolitan area networks, a direct connection such as through a Universal Serial Bus (USB) port, or any other networks that may allow for data communication. The network 414 may be configured to couple one computing device to another computing device to enable communication of data between the devices. The network 414 may generally be enabled to employ any form of machine-readable media for communicating information from one device to another. The network 414 may include communication methods by which information may travel between computing devices. The network 414 may be divided into sub-networks. The sub-networks may allow access to all of the other components connected thereto or the sub-networks may restrict access between the components. The network 414 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations may include distributed processing, component/object distributed processing, and parallel processing. Alternatively, virtual computer system processing may be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

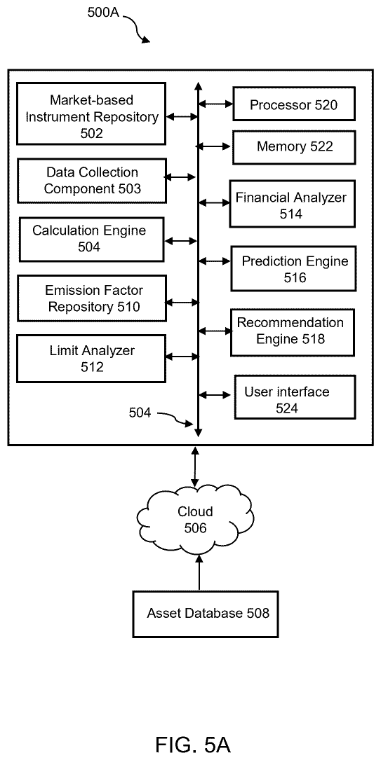

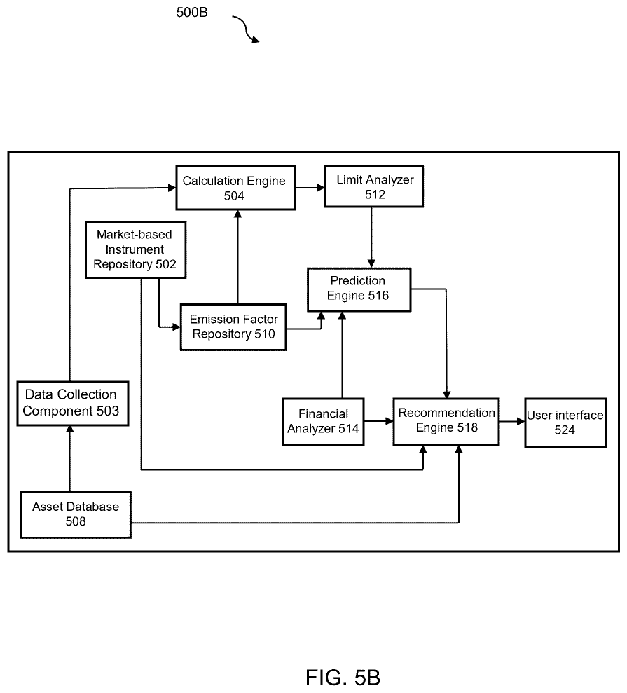

FIG. 5A is an exemplary block diagram illustrating an implementation of a market instrument management system 500A in the facility, in accordance with one or more embodiments of the present disclosure. In accordance with one or more example embodiments, the market instrument management system 500A described herein manages emissions associated with the plurality of processes and/or assets in the facility. In accordance with one or more example embodiments, the market instrument management system described herein manages the market-based instruments such as carbon certificates efficiently and effectively. In this regard, the market instrument management system 500A receives telemetry data from one or more sensors associated with each of the plurality of assets. Further, the market instrument management system 500A processes the telemetry data to determine one or more insights. For example, the market instrument management system 500A processes the telemetry data to determine emission level associated with an asset. Further, in another example, the market instrument management system 500A processes the telemetry data to determine one or more corrective actions. Whereas in another example, the market instrument management system 500A processes the telemetry data to determine one or more root causes associated with a particular trend of operations or emissions associated with the processes and/or assets. Yet in another example, the market instrument management system 500A processes the telemetry data to determine one or more predictions associated with a particular trend of operations or emissions associated with the processes and/or assets. Also, in some example embodiments, the market instrument management system 500A constructs a model related to the operations or emissions associated with the processes and/or assets based on the processed telemetry data. In addition, in some example embodiments, the market instrument management system 500A undertakes relevant actions based on the one or more insights. Accordingly, the market instrument management system 500A facilitates a practical application of data analytics technology and/or digital transformation technology to efficiently control the plurality of processes and/or assets and manage emissions in the facility.

In an example embodiment, the market instrument management system 500A is a server system (e.g., a server device) that facilitates a data analytics platform between one or more computing devices, one or more data sources, and/or one or more assets. In one or more example embodiments, the market instrument management system 500A is a device with one or more processors and a memory. Also, in some example embodiments, the market instrument management system 500A is implementable via the cloud 106. The market instrument management system 500A is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

In some example embodiments, the market instrument management system 500A comprises one or more components and/or sub-systems such as a market-based instrument repository 502, a data collection component 503, a calculation engine 504, an asset database 508, an emission factor repository 510, a limit analyzer 512, a financial analyzer 514, a prediction engine 516, a recommendation engine 518, and/or user interface 524. Additionally, in one or more example embodiments, the market instrument management system 500A comprises processor 520 and/or memory 522. In one or more example embodiments, one or more components and/or sub-systems of the market instrument management system 500A may be communicatively coupled to processor 520 and/or memory 522 via a bus 504. In certain example embodiments, one or more aspects of the market instrument management system 500A (and/or other systems, apparatuses and/or processes disclosed herein) constitute executable instructions embodied within a computer-readable storage medium (e.g., the memory 522). For instance, in an example embodiment, the memory 522 stores computer executable component and/or executable instructions (e.g., program instructions). Furthermore, the processor 520 facilitates execution of the computer executable components and/or the executable instructions (e.g., the program instructions). In an example embodiment, the processor 520 is configured to execute instructions stored in memory 522 or otherwise accessible to the processor 520.

The processor 520 is a hardware entity (e.g., physically embodied in circuitry) capable of performing operations according to one or more embodiments of the disclosure. Alternatively, in an example embodiment where the processor 520 is embodied as an executor of software instructions, the software instructions configure the processor 520 to perform one or more algorithms and/or operations described herein in response to the software instructions being executed. In an example embodiment, the processor 520 is a single core processor, a multi-core processor, multiple processors internal to the market instrument management system 500A, a remote processor (e.g., a processor implemented on a server), and/or a virtual machine. In certain example embodiments, the processor 520 is in communication with the memory 522, the market-based instrument repository 502, the data collection component 503, the calculation engine 504, the asset database 508, the emission factor repository 510, the limit analyzer 512, the financial analyzer 514, the prediction engine 516, the recommendation engine 518, and/or the user interface 524 via the bus 504 to, for example, facilitate transmission of data between the processor 520, the memory 522, the market-based instrument repository 502, the data collection component 503, the calculation engine 504, the asset database 508, the emission factor repository 510, the limit analyzer 512, the financial analyzer 514, the prediction engine 516, the recommendation engine 518, and/or the user interface 524. In some example embodiments, the processor 520 may be embodied in a number of different ways and, in certain example embodiments, includes one or more processing devices configured to perform independently. Additionally or alternatively, in one or more example embodiments, the processor 520 includes one or more processors configured in tandem via bus 504 to enable independent execution of instructions, pipelining of data, and/or multi-thread execution of instructions.

The memory 522 is non-transitory and includes, for example, one or more volatile memories and/or one or more non-volatile memories. In other words, in one or more example embodiments, the memory 522 is an electronic storage device (e.g., a computer-readable storage medium). The memory 522 is configured to store information, data, content, one or more applications, one or more instructions, or the like, to enable the market instrument management system 500A to carry out various functions in accordance with one or more embodiments disclosed herein. In accordance with some example embodiments described herein, the memory 522 may correspond to an internal or external memory of the market instrument management system 500A. In some examples, the memory 522 may correspond to a database communicatively coupled to the market instrument management system 500A. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the market-based instruments repository or a carbon certificate repository 502 refers to a centralized database where a plurality of carbon certificates is stored. The carbon certificates are tangible assets that represent verified reductions or removals of GHG emissions. They are essential tools in global efforts to combat climate change by enabling organizations and individuals to offset their carbon footprints or GHG emissions and support sustainable development initiatives worldwide. Carbon certificates play a critical role in incentivizing emissions reductions globally, supporting sustainable development, and facilitating the transition to a low-carbon economy by providing financial incentives for climate-friendly projects. The carbon certificates may be generated from various types of carbon offset projects, including renewable energy projects (such as wind, solar, hydro), energy efficiency projects, afforestation and reforestation projects, methane capture projects from landfills or agriculture, and others that reduce GHG emissions. Each of the plurality of carbon certificates may be purchased from verified certificate providers. In some example embodiments, the plurality of carbon certificates and associated contextual information may be uploaded in the market-based instruments repository 502 either manually or automatically. In another embodiment, some of the plurality of carbon certificates may be specific to the geographic location of the site or the facility. The market-based instruments repository 502 may store ledger information such as, but not limited to, total number of carbon credits issued by the government agency or the independent certification body corresponding to each certificate or the total number of purchased carbon credits, total number of carbon credits already used, balance details such as total number of remaining carbon credits, and/or like. Further, the market-based instruments repository 502 may store the contextual information about each carbon certificate such as, but not limited to, certificate identity data (ID), details of certificate issuance authority, type of certificate, emission rate, capacity, date of issue of the certificate, expiry date of the issued carbon credits, details of the project for which the carbon credits have been purchased, residual emission factors, region or location information corresponding to each certificate, and/or like. The market-based instruments repository 502 may also store information such as history of the certificate, when the certificate was last applied, carbon emission target of the site, actual emissions accounted till date corresponding to the asset or the site, and/or like. The carbon emission target refers to a specific goal set by an organization, government, or an entity that indicates the total amount of carbon dioxide (CO2) and other greenhouse gas (GHG) emissions that is released into the atmosphere over a specific period. In an embodiment, the specific period may be week, months, or years. The aim is to reduce emissions by a certain percentage or amount compared to a baseline year. The facilities may set the carbon emission target as part of corporate sustainability strategies. The carbon emission target may also be set based on location of the site. The actual emissions corresponding to the site includes compiling data on GHG emissions from various emission sources and/or the assets at the specific site within a specified timeframe. The calculation of actual emissions involves tracking data on energy consumption, fuel use, production levels, and other relevant activities that generate GHG emissions.

In one or more embodiments, the asset database 508 may store asset hierarchy for a specific site. In another embodiment, the asset database 508 may store asset hierarchies of multiple sites at different locations corresponding to the facility. The assets represent different types of emission sources that are present within the facility. The emission sources may include, but not limited to, stationary sources, mobile sources, process emissions, or indirect sources. In some example embodiments, at least some of the assets are, but not limited to physical assets such as equipment, machinery, boilers, chillers, Heating, ventilation, and air conditioning (HVAC) systems, turbines, conveyors, and/or like. For example, industrial assets such as machinery or equipment used in manufacturing, processing, or energy production may emit gases such as carbon dioxide (CO2), methane (CH4), nitrous oxide (N2O), sulfur dioxide (SO2), and volatile organic compounds (VOCs). Vehicles used for transporting goods emit carbon dioxide (CO2), nitrogen oxides (NOx), particulate matter (PM), and other pollutants depending on the type of fuel used (gasoline, diesel, electric, etc.). The HVAC system, boilers, and generators may emit carbon dioxide and other gases depending on their energy source (natural gas, oil, electricity). Further, the one or more sensors may correspond to cameras, gas detectors, flow meters, temperature sensors, pressure sensors, heat sensors, flow rate sensors, position sensors, and/or the like. Per this aspect, the one or more sensors sense telemetry data such as emission levels, a type of material handled, a process handled, and/or the like associated with the assets. The emission levels may be calculated via the flow meters, or direct measurement methods such as, but not limited to, gas cloud imaging (GCI), sensors, drones, satellites, etc. In an example, the flow meters may be installed on relevant equipment or pipelines to measure the amount of fuel consumed over a specific period. In another example, the drones may collect visual or sensor data to assess the scale and intensity of activities related to the emissions sources. In yet another example, a gas cloud imaging (GCI) camera may be used to sense emission data (say, gas speciation and concentration along with geospatial co-ordinates) associated with at least some of the emission sources. In this regard, the gas cloud imaging (GCI) camera transmits the emission data to the data collection component 503 (as described in detail below). Further, the asset database 508 may store site or facility specific details such as geographic location details. Furthermore, the asset database 508 may store location information of the assets, asset identification data, maintenance records of the assets, warranty information, fault data, and/or like.

In one or more embodiments, the data collection component 503 receives data associated with the assets stored in the asset database 508. Further, the data collection component 503 may process the received data to determine one or more parameters. Specifically, in some examples, the one or more parameters may be related to emissions in the facility. For example, the one or more parameters may correspond to a type of operation performed by the asset being responsible for a specific intensity of emission in the facility. Further, in another example, the one or more parameters may correspond to a type or nature of material handled by an asset being responsible for a particular emission. Yet in another example, the one or more parameters may correspond to a process or workflow performed by an asset being responsible for emissions.

In one or more embodiments, the emission factor repository 510 may store emission factors corresponding to various emission sources such as the assets of the particular site or the facility. The emission factors are crucial parameters used to estimate the emissions from various emission sources. The emission factors may be provided by organizations such as Environmental Protection Agency (EPA) in the United States and other governmental or international bodies. The GHG Protocol, developed by the World Resources Institute (WRI) and the World Business Council for Sustainable Development (WBCSD), also provides standardized emission factors for calculating the emissions. These factors have been widely used globally for GHG accounting and reporting. These emission factors represent an average emission rate of a given pollutant for a specific type of source, activity, or fuel consumption. The emission factor is a standardized coefficient that quantify the amount of GHGs emitted per unit of activity. The emission factors may be expressed in units of mass of pollutant per unit of activity, such as grams of carbon dioxide per kilometer traveled by a vehicle or kilograms of methane per metric ton of waste disposed of, and/or like. The emission factor repository 510 is a centralized collection of data that helps in estimating emissions of GHGs or pollutants from various sources and activities. The emission factor repository 510 is an essential tool for environmental assessment, regulatory compliance, emissions reporting, and developing emissions inventories. Further, the emission factor repository 510 may be periodically updated to incorporate new emission factors. The emission factor repository 510 may include metadata such as source of the emission factor, methodology used for the calculation, and/or any other specific conditions. The emission factors may be categorized in the emission factor repository 510 based on the pollutant type and/or the emission source. In some example embodiments, the overall emissions at the specific site or the facility may be calculated using emission factors that quantify an amount of CO2-equivalent emissions produced per unit of activity or energy consumed.

In some embodiments, the calculation engine 504 applies one or more functions (say, related to emissions) to the one or more parameters and/or the emission factors to calculate total actual emissions in real time. In this regard, the one or more functions may be related to overall emissions of the facility, specific type of emissions, emission level associated with the one or more assets, correlation of emission level, emission level associated with one or more processes, and/or the like. For example, a function of the one or more functions may correlate the one or more parameters with the emission factors. In another example, a function of the one or more functions may determine the total actual emissions in the facility. Further, in another example, a function of the one or more functions may determine the total actual emissions associated with one or more workflows of a particular industrial process. Yet in another example, a function of the one or more pre-defined functions may determine the total actual emissions associated with the one or more processes and/or assets. In accordance with some example embodiments, the one or more functions may be based at least in part on historic data associated with the facility. Also, in some example embodiments, the calculation engine 504 generates the one or more functions in near-real time. For example, the calculation engine 504 may generate a function with one or more emission equations. Then, the calculation engine 504 may apply the one or more emission equations on the received data. Accordingly, based at least on the one or more emission equations, the calculation engine 504 may calculate the total actual emissions for each of the one or more assets. Further, the processor 520 may translate the total actual emission calculations to understandable insights around the emission levels. Also, the calculation engine 504 may transmit the total actual emission calculations to the limit analyzer 512.

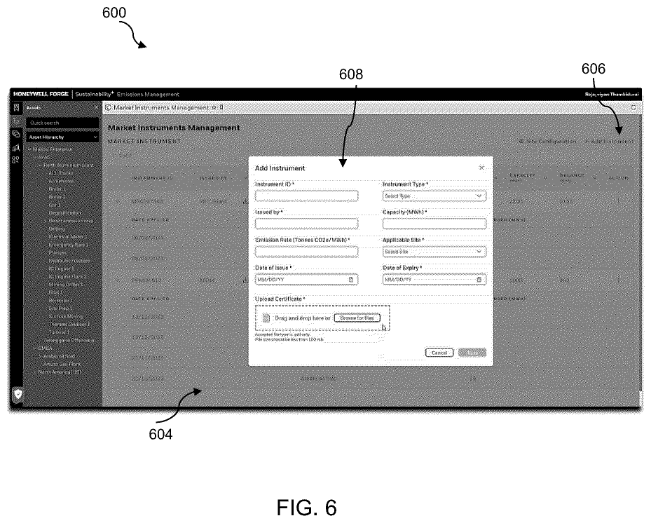

In one or more example embodiments, the limit analyzer 512 comprises one or more limits associated with emissions of the assets in the facility. In this regard, the one or more limits may represent values for emissions in the facility. The limit analyzer 512 may include data related to such as, but not limited to permissible emissions associated with the assets, safe emission levels, standard emission levels set by regulatory, one or more thresholds, and/or the like. Based on the aforementioned data, the limit analyzer 512 may derive the one or more limits. In one or more embodiments, the limit analyzer 512 may keep a check on the total actual emissions for the specific site. Ideally, the total actual emissions should not exceed the carbon emission target. However, since certain emissions cannot be controlled, the total actual emissions may sometimes exceed the carbon emission target. In some example embodiments, the limit analyzer 512 may keep a track of the total actual emissions with respect to the carbon emission target. Further, the limit analyzer 512 may perform a comparison between the total actual emissions and the carbon emission target in real-time and as a result, generates a result of the comparison. In some example embodiments, the processor 520 may display the result of the comparison on the user interface 524 of the display device (as shown in FIGS. 6 to 9). Per this aspect, the processor 520 may determine if the facility is in compliance standards prescribed by regulatory based on the result of the comparison. For instance, if the comparison of the total actual emissions exceeds the carbon emission target, then the processor 520 may determine non-compliance with the standards. Whereas in another instance, if the comparison of the total actual emissions exceeds the carbon emission target, then the processor 520 may identify one or more corrective actions (discussed in detail below).

In one or more embodiments, the financial analyzer 514 may represent a tool used to assess the financial implications of the emissions within the facility. The financial value analyzer 514 may incorporate carbon pricing mechanisms, which assign a monetary value for per ton of CO2 or equivalent emissions. In one or more embodiments, the carbon pricing mechanisms may be based on location/geographical region, consortium or agency guidelines across the site or the facility, internal cost estimates, regulatory requirements (carbon taxes or cap-and-trade systems), or market prices for the carbon credits, and/or like. The financial value analyzer 514 may calculate the financial impact of the emissions on the facility. This may include direct costs associated with purchasing carbon credits to offset the emissions. The financial value analyzer 514 may assist decision makers to evaluate different carbon reduction strategies and their financial implications and assess the costs and benefits of investing in emission reduction technologies, energy efficiency improvements, or renewable energy sources.

In one or more embodiments, the prediction engine 516 is continuous learning AI/ML driven that leverages advanced algorithms to predict total emissions for the specific period or a time frame, emission intensity for the specific period, financial impact corresponding to the particular site for the specific period, and/or like. In one embodiment, the prediction engine 516 may predict the emissions that may be offset from the predicted total emissions. In another embodiment, the prediction engine 516 may predict total emissions for the specific period corresponding to at least one carbon certificate of the plurality of carbon certificates. The at least one carbon certificate is applicable to the geographical location of the site or facility for which the total emissions are being predicted. The prediction engine 516 may predict the total emissions for all gas types. In some example embodiments, the one or more predictions may be, but not limited to emission levels of the assets and/or overall facility, trends of emissions, emission trend of a particular gas in the facility, operations of the assets and/or processes, a potential consequence based on fugitive emissions, a particular trend of operations or emissions associated with the processes and/or assets, a particular trend of operations of assets for a specific time window, a particular trend of emissions for a specific time window, emissions that are likely to be emitted for a particular workflow of a process, and/or the like. The predictions corresponding to each certificate are based on historical data, real-time inputs, the financial value, and relevant contextual factors. The historical data refers to past emission data for the facility over time. The real-time inputs include, but are not limited to, the carbon emission target, the actual calculated emissions, credits to be applied to meet the carbon emissions target, and/or like. The financial value is the monetary value for per ton of emissions. The relevant contextual factors may include the emission factors corresponding to various emission sources, residual emission factors corresponding to each certificate, and/or like. In some embodiment, the prediction engine 516 may predict the overall carbon emissions at the site and the financial implications corresponding to the at least one carbon certificate.

In one or more embodiments, the recommendation engine 518 may generate recommendations including at least one carbon certificate from the plurality of certificates that may be applied to achieve carbon offsetting across the site or the facility. Further, the generated recommendations include the number of carbon credits procured from each certificate from the plurality of certificates. In this regard, the recommendation engine is configured to generate audit logs corresponding to each carbon certificate. In one embodiment, certain rules may be configured corresponding to the recommendation engine 518 based on which the recommendations are provided. For instance, in one exemplary embodiment, the rules may be configured based on preferences of the personnel whether the personnel want to exceed the total actual emissions beyond the carbon emission target and ready to pay penalty to the agencies. In another exemplary embodiment, the rules may be configured such that the appropriate carbon certificates need to be applied from the market-based instrument repository 502 to offset their emissions. While generating recommendations, sufficient weightage may be provided to the financial implications determined by the financial value analyzer. Further, the recommendations may be generated based on different data points such as the total emission predictions, the validity of the carbon certificates, the ledger information, applicable site or region, residual emission factors, the contextual information corresponding to the carbon certificate, the asset hierarchy, the site or enterprise specific details, the location information of the site, the location information of the assets, and/or like. Once the recommendations are generated, the user input may be required to approve the generated recommendations and accordingly the recommendations are applied. In some embodiments, the recommendation engine 518 may recommend purchasing of new carbon certificates based on the total emission predictions performed by the prediction engine. In some exemplary embodiments, the purchasing of new carbon certificates may be performed manually or automatically. In first scenario, the new carbon certificates may be manually purchased by the personnel based on the predicted total emissions and the market instrument management system 500A validates the new carbon certificates. After the purchase of the new carbon certificates, the new carbon certificates may be uploaded in the market-based instrument repository 502 manually or automatically. In second scenario, the recommendation engine 518 may initiate auto-purchase of new carbon certificates. There could be various other factors as well that affects the recommendation of purchasing of the carbon credits or the carbon certificates. The first factor could be prediction of breach in the carbon emission target for a particular region or site. The second factor could be prediction of breach in timeline set to become net-zero. The third factor could be there may not be any carbon certificate with offsets/credits available in the repository that could be applied to offset the emissions. The fourth factor could be preferences set by the customer to offset the carbon emissions instead of paying penalty to the regulatory bodies. The fifth factor could be the type of carbon certificates. The sixth factor could be the number of credits/offsets that needs to be purchased. The seventh factor could be the timeline by when the carbon-based certificates need to be purchased. The eighth factor could be the budget of the purchase. There could be multiple other factors as well. The purchase of carbon credits/certificates may be done in advance such that the facilities could be well prepared for financial obligations towards carbon offsetting. In addition, an Advanced carbon credit estimation algorithm may assist in buying carbon credits at lower prices.

Further, in some example embodiments, the market instrument management system 500A utilizes the machine learning algorithm to provide the one or more insights based on the one or more predictions and/or one or more recommendations. Said alternatively, the machine learning algorithm comprises one or more models that can be used by the market instrument management system 500A to provide the one or more insights. Also, in some example embodiments, the machine learning algorithm may be trained with one or more datasets to facilitate provision of the one or more insights. In this regard, the one or more datasets may be related to carbon certificates and associated contextual information available in the market-based instrument repository 502, asset data stored in the asset database 508, emissions associated with the assets and/or processes in the facility, financial data, predictions, and/or recommendations. In some example embodiments, the one or more datasets may be, but not limited to historical data related to emissions the facility, emission profile associated with the facility, emission profiles for particular assets and/or processes in the facility, emission intensities of particular gases in the facility, regulatory standards, historical financial impacts, historical corrective actions, historical opportunities, historical recommendations, historical predictions, and/or the like. Further, in some example embodiments, the machine learning algorithm defines the one or more thresholds. Specifically, in some example embodiments, the one or more thresholds can be associated with emissions. In this regard, the machine learning algorithm may define the one or more thresholds based on rules or safe emission levels prescribed by regulatory, emission profiles associated with assets and/or processes in the facility, etc. Additionally, in some example embodiments, the one or more insights may be provided as feedback. Whereas in some example embodiments, the personnel in the facility may also provide feedback on the one or more insights or input actions undertaken by them. In this regard, the machine learning algorithm may learn over time to provide improved and accurate insights. For example, the market instrument management system 500A may flag one or more actions taken by the personnel in the facility if they are determined to have caused a spike in emissions in the facility. In another example, the market instrument management system 500A may generate new insights based on one or more actions taken by personnel in the facility. Also, in some example embodiments, the machine learning algorithm may be trained with one or more new datasets on a regular basis or for a pre-defined time interval to improve relevancy of insights.

Further, in some example embodiments, the one or more insights may be transmitted to the user interface 524. Per this aspect, the one or more insights may be rendered on the user interface 524. In one or more embodiments, the user interface 524 is configured to display the one or more insights. The one or more insights may be presented in the form reports, dashboard, descriptions, charts, trends, graphs, and/or like. The one or more insights may be related to emissions, carbon offsetting, financial impact, predictions, recommendations, and/or like. In one or more example embodiments, one or more corrective actions related to emissions and the carbon offsetting may be rendered on the user interface 524. In another example, financial impact or implications related to carbon offsetting may be rendered on the user interface 524. In another example, one or more predictions related to emissions in the facility may be rendered on the user interface 524. In another example, one or more recommendations related to the carbon certificates may be rendered on the user interface 524. Yet in another example, the one or more root causes related to the emissions may be rendered on the user interface 524. The user interface 5008 can correspond to an interface of a device associated with personnel in the facility. In one example, the user interface 524 may correspond to an interface of a device associated with an operator or the personnel in the facility. In another example, the user interface 524 may correspond to an interface of a device associated with a supervisor of the operator in the facility. In some example embodiments, one or more alert signals may be generated based on the one or more insights. In some example embodiments, the one or more alert signals may be transmitted to the user interface 524. In this regard, in some example embodiments, one or more notifications may be generated on the user interface 524 based on the one or more alert signals. Accordingly, in some examples, the one or more notifications may be visual notifications. Whereas, in some examples, the one or more notifications may be audio notifications. Also, in some example embodiments, the user interface 524 may allow the personnel to provide input and/or feedback regarding the one or more insights. For example, an input may correspond an operator selecting a corrective action. In another example, an input may correspond the personnel approving the recommended carbon certificates. In this regard, the one or more insights may be rendered as visualizations, such as on the user interface 524, to help the personnel such as field operators to identify the one or more insights and thereby undertake appropriate actions. An exemplary user interfaces are also described in more details in accordance with FIGS. 6 to 9 of the current disclosure.

In some example embodiments, the one or more components, one or more sub-systems, processor 520 and/or memory 522 of the market instrument management system 500A may be communicatively coupled to cloud 506 over a network. In this regard, the one or more components, processor 520 and/or memory 522 along with the cloud 506 control the plurality of processes and/or assets and manage emissions in the facility. In some example embodiments, the network may be for example, a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, a BACnet network, a NIAGARA network, a NIAGARA CLOUD network, and/or another type of network. In some example embodiments, the telemetry data received from the one or more assets may be transmitted to the cloud 506. In some example embodiments, the cloud 506 may be configured to perform one or more operations/functionalities of the one or more components, one or more sub-systems, processor 520 and/or memory 522 of the market instrument management system 500A.

FIG. 5B illustrates a schematic diagram showing an exemplary market instrument management system 500B in accordance with one or more embodiments of the present disclosure. In some example embodiments, exemplary market instrument management system 500B described herein corresponds to market instrument management system 500A described in FIG. 5A of the current disclosure. According to various example embodiments described herein, the market instrument management system 500B comprises one or more components such as the market-based instrument repository 502, the data collection component 503, the calculation engine 504, the asset database 508, the emission factor repository 510, the limit analyzer 512, the financial analyzer 514, the prediction engine 516, the recommendation engine 518, and/or the user interface 524. In accordance with one or more example embodiments, the aforementioned one or more components facilitate the market instrument management system 500B to provide predictions, recommendations and/or the like as described in FIG. 5A of the current disclosure.

In one or more example embodiments, the market-based instruments repository 502 may store a plurality of carbon certificates. The market-based instruments repository 502 may store contextual information associated with each of the plurality of carbon certificates. Further, the market-based instruments repository 502 may store credit/debit ledger information associated with each of the plurality of carbon certificates, balance credits associated with each of the plurality of carbon certificates, details related to when the specific carbon certificate was last applied, and/or like.

In some example embodiments, the data collection component 503 is configured to receive data, such as telemetry data from the asset database 508, via the cloud network 506. Also, in some example embodiments, the data collection component 503 is configured to directly receive the telemetry data from the one or more assets in a facility as well. In some example embodiments, the data collection component 503 may receive emission data associated with the one or more assets via the one or more sensors associated with the one or more assets. In some example embodiments, the data collection component 503 is configured to receive data related to asset hierarchy from the asset database 508. Also, in some example embodiments, the data collection component 503 may pre-process the received data in a format that is compatible with other components of the market instrument management system 500B. Further, the data collection component 503 transmits the data to the calculation engine 504. In some example embodiments, the overall emissions at the specific site or the facility may be calculated using emission factors associated with the emission sources that quantify an amount of CO2-equivalent emissions produced per unit of activity or energy consumed. In one or more example embodiments, the calculation engine 504 comprises the one or more functions that may be applied on the data transmitted by the data collection component 503 and/or the emission factors stored in the emission factor repository 510 to calculate the total actual emissions in real time. The calculation engine 504 transmits the total actual emissions calculations to the limit analyzer 512.

In some example embodiments, the limit analyzer 512 may compare the total actual emissions associated with the assets in the facility with the carbon emission target to determine if the total actual emissions in the facility are compliant with the carbon emission target. For example, the total actual emissions outputted by the calculation engine 504 may be compared with the carbon emission target. Further, the limit analyzer 512 may transmit the result of the comparison to the prediction engine 516. In some example embodiments, the financial value analyzer 514 may calculate the financial impact of the emissions in the facility. This may include direct costs associated with purchasing of carbon credits to offset the emissions.

In one or more embodiments, the prediction engine 516 is continuous learning AI/ML driven that leverages advanced algorithms to predict the total emissions for the specific period or the time frame, the emission intensity for the specific period, the financial impact corresponding to the particular site for the specific period, and/or like. In one embodiment, the prediction engine 516 may predict the emissions that may be offset from the predicted total emissions. In another embodiment, the prediction engine 516 may predict the total emissions for the specific period corresponding to at least one carbon certificate of the plurality of carbon certificates. The at least one carbon certificate is applicable to the geographical location of the site or facility for which the total emissions are being predicted. The prediction engine 516 may predict the total emissions for all gas types. In some example embodiments, the one or more predictions may be, but not limited to the emission levels of the assets and/or overall facility, trends of emissions, emission trend of a particular gas in the facility, operations of the assets and/or processes, a potential consequence based on fugitive emissions, a particular trend of operations or emissions associated with the processes and/or assets, a particular trend of operations of assets for a specific time window, a particular trend of emissions for a specific time window, emissions that are likely to be emitted for a particular workflow of a process, and/or the like. The predictions corresponding to each certificate are based on the historical data, real-time inputs, the financial value, and the relevant contextual factors. The historical data refers to past emission data for the facility over time. The real-time inputs include, but are not limited to, the carbon emission target, the actual calculated emissions, credits to be applied to meet the carbon emissions target, and/or like. The financial value is the monetary value for per ton of emissions. The relevant contextual factors may include the emission factors corresponding to various emission sources, residual emission factors corresponding to each certificate, and/or like. In some embodiment, the prediction engine 516 may predict the overall carbon emissions at the site and the financial implications corresponding to the at least one carbon certificate. The prediction engine 516 may transmit the one or more predictions to the recommendation engine 518.

In one or more embodiments, the recommendation engine 518 may generate recommendations including at least one carbon certificate from the plurality of certificates that may be applied to achieve carbon offsetting across the site or the facility. Further, the generated recommendations include the number of carbon credits procured from each certificate from the plurality of certificates. In this regard, the recommendation engine is configured to generate audit logs corresponding to each carbon certificate. In one embodiment, certain rules may be configured corresponding to the recommendation engine 518 based on which the recommendations are provided. While generating recommendations, sufficient weightage may be provided to the financial implications determined by the financial value analyzer. Further, the recommendations may be generated based on different data points such as the total emission predictions, the validity of the carbon certificates, the ledger information, applicable site or region, residual emission factors, the contextual information corresponding to the carbon certificate, the asset hierarchy, the site or enterprise specific details, the location information of the site, the location information of the assets, and/or like. Once the recommendations are generated, the user input may be required to approve the generated recommendations and accordingly the recommendations are applied. In some embodiments, the recommendation engine 518 may recommend purchasing of new carbon certificates based on the total emission predictions performed by the prediction engine. In some exemplary embodiments, the purchasing of new carbon certificates may be performed manually or automatically.

Further, in some example embodiments, the market instrument management system 500A utilizes the machine learning algorithm to provide the one or more insights based on the one or more predictions and/or one or more recommendations. Further, in some example embodiments, the one or more insights may be transmitted to the user interface 524. In one or more embodiments, the user interface 524 is configured to display the one or more insights. The one or more insights may be presented in the form reports, dashboard, descriptions, charts, trends, graphs, and/or like. The one or more insights may be related to emissions, carbon offsetting, financial impact, predictions, recommendations, and/or like.

FIG. 6 is an exemplary illustration of uploading a market-based instrument via the user interface 604, in accordance with one or more embodiments of the present disclosure. In one or more example embodiments, the user interface 604 described herein is a part of a display device 600. The display device 600 for instance, may be, but not limited to a mobile device, a wearable device, a smart glass with augmented reality functions, a tablet computer, a laptop, a desktop computer and/or the like. In order to upload the market-based instrument in the market-based instrument repository 502 (as described in FIGS. 5A and 5B), select “Add instrument” tab 606 on the user interface 604. Further, “Add instrument” window 608 is displayed on the user interface 604. In one embodiment, the personnel may enter the contextual information manually related to the market-based instrument in the window 608. The contextual information may include Instrument ID, Issued by, Emission Rate, Date of Issue, Instrument Type, Capacity, Applicable Site, and Date of Expiry. In addition, the personnel may upload the market-based instrument under the Upload Certificate option. In another embodiment, the details may be auto-populated in the “Add instrument” window 608 based on the market-based instrument. Similarly, the plurality of market-based instruments may be uploaded in the market-based instrument repository 502 either manually or automatically. In some example embodiments, the exemplary user interface 604 described herein corresponds to user interface 524 described in FIGS. 5A and 5B of the current disclosure. The user interface 604 described herein is an intuitive interface that receives inputs from personnel such as field operators in a facility and provides corresponding outputs for display. The operators in the facility may provide the inputs to perform “what-if” analysis so as to understand various situations and undertake appropriate actions. Additionally, the user interface 604 may also render the one or more insights provided by the market instrument management system 500A or 500B (specifically, by recommendation engine 518) In some example embodiments, the one or more insights may be rendered in formats such as graphs, dashboards, descriptions, trends, and/or the like.

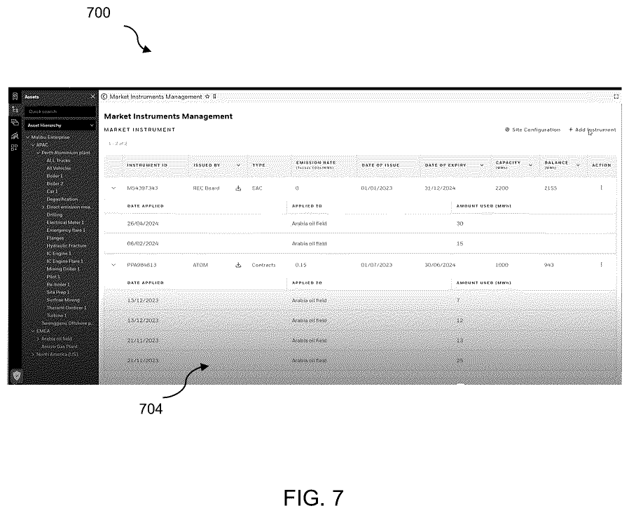

FIG. 7 is an exemplary illustration of the plurality of market-based instruments via the user interface 704, in accordance with one or more embodiments of the present disclosure. In one or more example embodiments, the user interface 704 described herein is a part of the display device 700. The display device 700 may correspond to the display device 600 as described in FIG. 6 of the current disclosure. The user interface 704 presents market-based instruments and associated contextual information that is being uploaded to the market-based instrument repository 502. The contextual information includes Instrument IDs (MS4397343, pp 84813 A9), Issued By (REC Board, ATOM), Instrument Type (EAC, Contracts), Emission Rate (0, 0.15), Date of Issue (01/01/2023, Jan. 7, 2023), Date of Expiry (31/12/2024, 30/06/2024), Capacity (2200, 1000), Balance (2155, 943), and/or Amount used corresponding to Date Applied.

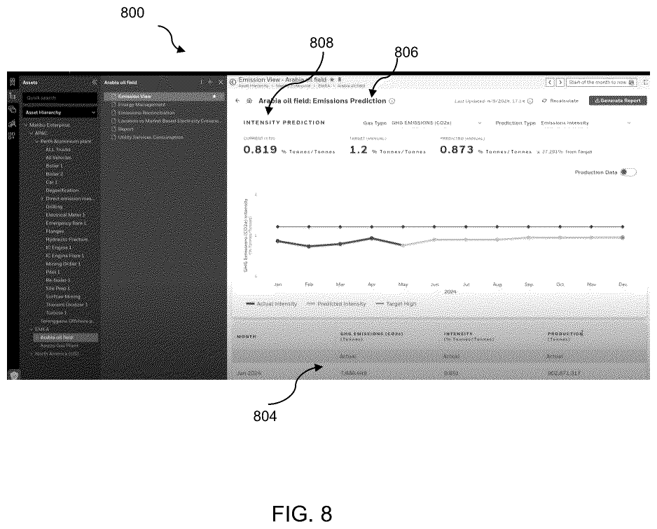

FIG. 8 is an exemplary illustration of an emission intensity prediction in the facility via the user interface 804, in accordance with one or more embodiments of the present disclosure. In one or more example embodiments, the user interface 804 described herein is a part of the display device 800. The display device 800 may correspond to the display device 600 as described in FIG. 6 of the current disclosure. The user interface 804 presents “Emission Prediction” window 806 of a particular facility such as “Arabia Oil Field”. The “Emission Prediction” window 806 presents intensity prediction 808. The intensity prediction 808 includes various parameters such as prediction type, gas type, current (year to date) intensity value, target (annual) value, predicted (annual) value. Further, the “Emission Prediction” window 806 presents values of actual intensity and predicted intensity over time. The aforementioned predictions assist in recommending the correct carbon certificate to offset the emissions in the facility.

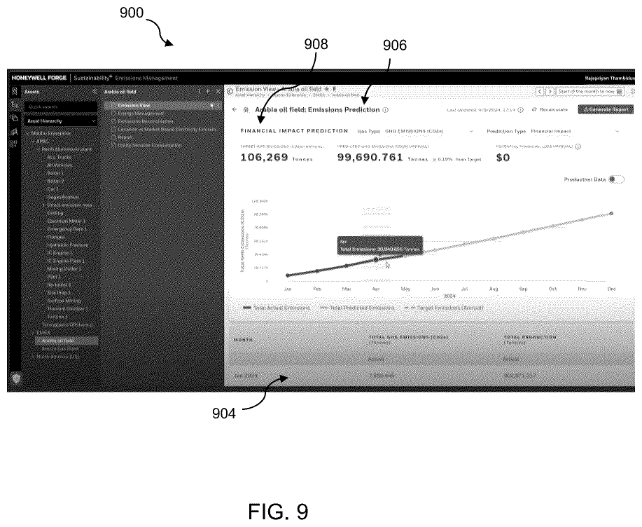

FIG. 9 is an exemplary illustration of a financial impact prediction in the facility via the user interface 904, in accordance with one or more embodiments of the present disclosure. In one or more example embodiments, the user interface 904 described herein is a part of the display device 900. The display device 900 may correspond to the display device 600 as described in FIG. 6 of the current disclosure. The user interface 904 presents “Emission Prediction” window 906 of a particular facility such as “Arabia Oil Field”. The “Emission Prediction” window 906 presents financial impact prediction 908. The financial impact prediction 908 includes various parameters such as prediction type, gas type, target GHG emissions value, predicted GHG emissions value, and potential financial loss (annual). Further, the “Emission Prediction” window 906 presents values of total actual emissions, total predicted emissions, and target emissions over time. The aforementioned predictions assist in recommending the correct carbon certificate to offset the emissions in the facility.

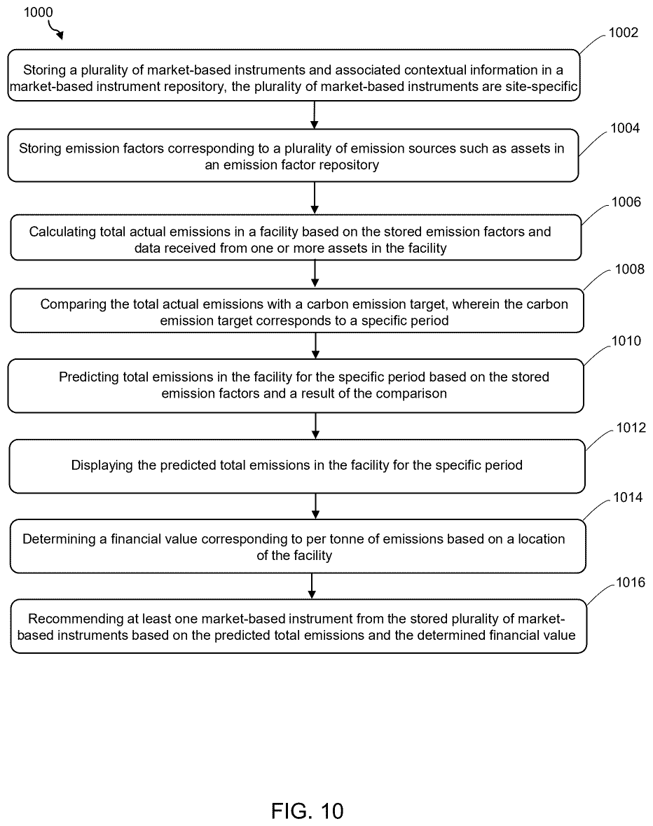

FIG. 10 is a flowchart illustrating example operations of managing the plurality of market-based instruments in the facility, in accordance with one or more embodiments of the present disclosure. An exemplary flowchart 1000 describes an exemplary method for managing the plurality of market-based instruments in the facility via the market instrument management system 500A (or 500B). At step 1002, the market instrument management system 500A includes means, such as the market-based instrument repository 502 to store a plurality of market-based instruments and associated contextual information, the plurality of market-based instruments are site-specific. At step 1004, the market instrument management system 500A includes means, such as the emission factor repository 510 to store emission factors corresponding to a plurality of emission sources such as assets. Further, at step 1006, the market instrument management system 500A includes means, such as the calculation engine 504 to calculate total actual emissions in a facility based on the stored emission factors and data received from one or more assets in the facility. At step 1008, the market instrument management system 500A includes means, such as the limit analyzer 512 to compare the total actual emissions with a carbon emission target, wherein the carbon emission target corresponds to a specific period. At step 1010, the market instrument management system 500A includes means, such as the prediction engine 516 to predict total emissions in the facility for the specific period based on the stored emission factors and a result of the comparison. At step 1012, the market instrument management system 500A includes means, such as the user interface 524 to display the predicted total emissions in the facility for the specific period. At step 1014, the market instrument management system 500A includes means, such as the financial analyzer 514 to determine a financial value corresponding to per tonne of emissions based on a location of the facility. At step 1016, the market instrument management system 500A includes means, such as the recommendation engine 518 to recommend at least one market-based instrument from the stored plurality of market-based instruments to offset the emissions based on the predicted total emissions and the determined financial value.

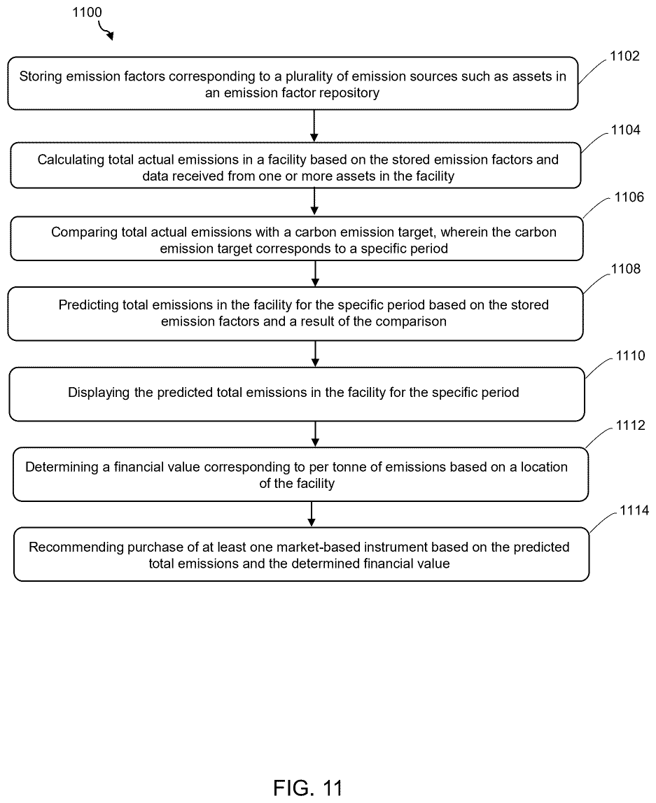

FIG. 11 is a flowchart illustrating example operations of managing the plurality of market-based instruments in the facility, in accordance with another embodiment of the present disclosure. An exemplary flowchart 1100 describes an exemplary method for managing the plurality of market-based instruments in the facility via the market instrument management system 500A (or 500B). At step 1102, the market instrument management system 500A includes means, such as the emission factor repository 510 to store emission factors corresponding to a plurality of emission sources such as assets. Further, at step 1104, the market instrument management system 500A includes means, such as the calculation engine 504 to calculate total actual emissions in a facility based on the stored emission factors and data received from one or more assets in the facility. At step 1106, the market instrument management system 500A includes means, such as the limit analyzer 512 to compare the total actual emissions with a carbon emission target, wherein the carbon emission target corresponds to a specific period. At step 1108, the market instrument management system 500A includes means, such as the prediction engine 516 to predict total emissions in the facility for the specific period based on the stored emission factors and a result of the comparison. At step 1110, the market instrument management system 500A includes means, such as the user interface 524 to display the predicted total emissions in the facility for the specific period. At step 1112, the market instrument management system 500A includes means, such as the financial analyzer 514 to determine a financial value corresponding to per tonne of emissions based on a location of the facility. At step 1114, the market instrument management system 500A includes means, such as the recommendation engine 518 to recommend purchase of at least one market-based instrument based on the predicted total emissions and the determined financial value.

The present disclosure is not only limited to greenhouse gases but is also applicable to other gases such as benzene that affects environment in one way or the other.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. A system for managing a plurality of market-based instruments in a facility, comprising:
a processor; and
a memory communicatively coupled to the processor, wherein the memory comprises one or more instructions which when executed by the processor, cause the processor to:
store emission factors corresponding to a plurality of assets in the facility;
calculate total actual emissions corresponding to the plurality of assets based on the stored emission factors;
compare the total actual emissions with a carbon emission target, wherein the carbon emission target corresponds to a specific period;
predict total emissions in the facility for the specific period based on the stored emission factors and a result of the comparison; and
display, via a user interface of a display device, the predicted total emissions in the facility.

2. The system of claim 1, wherein the processor is further configured to determine a financial value corresponding to per tonne of emissions based on a location of the facility.

3. The system of claim 2, wherein the processor is further configured to predict financial impact for the specific period based on the predicted total emissions and the determined financial value.

4. The system of claim 2, wherein the processor is further configured to recommend at least one market-based instrument from the plurality of market-based instruments based on the predicted total emissions and the determined financial value, wherein the at least one market-based instrument is recommended to offset emissions from the predicted total emissions that is above the carbon emission target.

5. The system of claim 4, wherein the processor is further configured to generate one or more insights based on the predicted total emissions and the recommended at least one market-based instrument.

6. The system of claim 1, wherein the processor is further configured to predict emission intensity for the specific period based on the predicted total emissions.

7. The system of claim 1, wherein the processor is further configured to store the plurality of market-based instruments and associated contextual information in a market-based instrument repository, wherein the associated contextual information includes at least one of ledger information, location information, validity information, and residual emission factors.

8. The system of claim 7, wherein the processor is further configured to recommend the at least one market-based instrument from the plurality of market-based instruments based on the associated contextual information and asset hierarchy corresponding to the plurality of assets.

9. The system of claim 1, wherein the processor is further configured to recommend purchase of at least one market-based instrument based on the predicted total emissions.

10. The system of claim 1, wherein the processor is further configured to predict the total emissions for at least one gas type of a plurality of gas types.

11. A method for managing a plurality of market-based instruments in a facility, comprising:
storing emission factors corresponding to a plurality of assets in the facility;
calculating total actual emissions corresponding to the plurality of assets based on the stored emission factors;
comparing the total actual emissions with a carbon emission target, wherein the carbon emission target corresponds to a specific period;
predicting total emissions in the facility for the specific period based on the stored emission factors and a result of the comparison; and
displaying, via a user interface of a display device, the predicted total emissions in the facility for the specific period.

12. The method of claim 11, further comprising determining a financial value corresponding to per tonne of emissions based on a location of the facility.

13. The method of claim 12, further comprising predicting financial impact for the specific period based on the predicted total emissions and the determined financial value.

14. The method of claim 12, further comprising recommending at least one market-based instrument from the plurality of market-based instruments based on the predicted total emissions and the determined financial value, wherein the at least one market-based instrument is recommended to offset emissions from the predicted total emissions that is above the carbon emission target.

15. The method of claim 14, further comprising generating one or more insights based on the predicted total emissions and the recommended at least one market-based instrument.

16. The method of claim 11, further comprising predicting emission intensity for the specific period based on the predicted total emissions.

17. The method of claim 11, further comprising storing the plurality of market-based instruments and associated contextual information in a market-based instrument repository, wherein the associated contextual information includes at least one of ledger information, location information, validity information, and residual emission factors.

18. The method of claim 17, further comprising recommending the at least one market-based instrument from the plurality of market-based instruments based on the associated contextual information and asset hierarchy corresponding to the plurality of assets.

19. The method of claim 11, further comprising recommending purchase of at least one market-based instrument based on the predicted total emissions.

20. The method of claim 11, further comprising predicting the total emissions for at least one gas type of a plurality of gas types.
